(19) United States
(12) Patent Application Publication
(10) Pub. No.: US 2009/0150873 A1
(43) Pub. Date: Jun. 11, 2009

(54) INFORMATION PROCESSING APPARATUS AND METHOD

(75) Inventor: Masakazu Taneda, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/095,876

(22) PCT Filed: Dec. 12, 2006
(86) PCT No.: PCT/JP2006/325139

§ 371 Date: Jun. 2, 2008

(30) Foreign Application Priority Data
Dec. 14, 2005 (JP) 2005-360836

(51) Int. Cl. G06F 9/45; G06F 3/12; B41J 29/38

(52) U.S. Cl. 717/148

(57) ABSTRACT

A data processing apparatus has an interpreter environment which dynamically executes programs configured based on a command set defined independently from a native command group, in a native environment. In the native environment input data streams are divided into multiple stages and intermediate data streams are generated for each of the states. In the interpreter environment the intermediate data streams are subjected to filtering processing and filtered data streams are generated. The intermediate data streams are handed to a filter via a layer interface. A data stream management attribute module extracts information of items specified beforehand from the intermediate data streams, and controls handing over of the intermediate data streams to the filter, based on the contents of the information. Thus, whether or not to apply filtering processing can be controlled based on description in the data streams, thereby realizing efficient data stream processing.

### TECHNICAL FIELD

The present invention relates to information processing technology using a native environment under which firmware and the like operates, and an interpreter environment operating under the native environment.

### BACKGROUND ART

Conventionally, software for executing image processing in image processing devices such as photocopiers or Multi Function Printers (MFPs), for example, has most often been configured as what is known as firmware, in a static and fixed manner on the operating system (OS). Even if such firmware is constituted internally of multiple modules, the firmware as a whole is stored in non-volatile memory in the device, with the entirety thereof being statically linked to a single load module. When the system is activated, the firmware is either loaded from the non-volatile memory, such as a hard disk or the like, to RAM, and executed, or is directly executed in the non-volatile memory, such as ROM in which the firmware is stored. With low-cost image processing devices in particular, firmware making up a built-in system is generally configured such that dynamic loading or linking of partial modules is not performed, for economic and safety reasons, among others. That is to say, the memory capacity for storing symbol tables necessary for achieving dynamic linking and overhead relating to processing of access addresses for symbols, causes declines in the device's cost-effectiveness. Another reason is that additional loading and linking of sub-modules could imperil the quality and security of the overall system, which would have been sufficient before linking to such sub-modules.

In order to solve the above problems, image processing devices have been developed which have another software operating environment layer above the realtime operating system on which the embedded system firmware runs. This additional software operating environment layer supports dynamic software properties, including but not limited to dynamic loading, dynamic linking, dynamic memory operations. The additional software operating environment constitutes an interpreter and an application programming interface (API) group or framework group, thereby providing a class of operating system or computing platform for the software running thereupon. The interpreter continuously reads out, interprets, and executes a series of command strings, made up of commands included in a predetermined command set. If this command set is viewed as being equivalent to a command set for the CPU, the interpreter may also be called a virtual machine. The set of API group and framework group provides the software running under the software operating environment with access to various types of resource groups, which are actual resources and hardware resources provided in abstract form by the realtime operating system in a layer below this software operating environment. These resources include, but are not limited to, command execution context carried out by processors, memory, filing systems, and various types of input/output (I/O), including network interfaces. In particular, with command execution contexts, the software operating environment is capable of proprietarily managing command execution contexts on the interpreter independently from multi-tasking functions provided by the CPU and the real time operating system. Also, with regard to memory management, the software operating environment can provide its own memory management.

Software which runs on such a software execution environment is sequentially read in and interpreted by the interpreter, and, accordingly, it may be possible to eliminate operations which adversely affect the system by monitoring the command stream during this process. Also, access to the various resources by the software running on the software execution environment is performed indirectly via the API group and framework group provided by the software execution environment. Accordingly, the approach of providing the hierarchical layer of the software execution environment made up of the interpreter, the API group, and the framework group within the firmware, may make it possible to eliminate operations which adversely affect the system in this accessing process. Accordingly, such an approach is extremely effective in partially introducing dynamic properties of software into firmware, in a low-cost built-in system that should be configured in a static and fixed manner; e.g., see Japanese Patent Laid-Open No. 11-282684 and Japanese Patent Laid-Open No. 2003-256216.

With the above approach, a Java (registered trademark) virtual machine can be employed as the interpreter for achieving the hierarchical level of the software execution environment, and API groups and framework groups relating to Java can be employed. The present assignee has, in the year 2003, commercialized an MFP having a Java platform built into the firmware of an image processing device.

Heretofore, there has been an arrangement wherein an application-downloading printer comprising a network computer is used to download, from a computer network to the printer, a data file to be printed, and an application corresponding to the data file. Activating and executing the downloaded application opens the data file, converts the data file into raster images, and prints the images. The fact that the application used in this case is a Java applet has been disclosed, as well as both cases of the application being pushed from the client along with the printing data file and the application being pulled by the printer from an application server or the like, e.g., Japanese Patent Laid-Open No. 11-53132.

Japanese Patent Laid-Open No. 11-306107 proposes a network communication system, wherein multiple peripheral devices, multiple terminal devices provided with software for operating the peripheral devices, and a server device having a device relating to software for operating the peripheral devices, at a minimum, are connected to a transmission path. With this network communication system, network communication is performed, based on a predetermined communication protocol, between the peripheral devices, the terminal devices, and the service device, which are connected to the transmission path. Here, the peripheral devices have a client control unit and a software distribution agent. The client control unit requests and obtains, from the server device, either software for operating the peripheral devices, in whole or in part, or the newest module information corresponding to modules used by the software. Also, the software distribution agent distributes the obtained newest modules to the terminal devices. According to Japanese Patent Laid-Open No. 306107, Java Applets and Java Applications can be supplied in this case as client-side modules to be used by the software to operate the peripheral devices.

On the other hand, with a backbone service system, the demand for maintaining the stability of an overall system, once it is running properly, is very strong, and there are cases wherein changes or version updates of printer drivers or applications and the like are not readily permitted. Given such real-world printing environment restrictions, it is the responsibility of printer vendors to handle various types of customer demands on the printer, rather than requiring the customer to do so. One method is to revamp the firmware making up the printer/printer controller and release this to each customer. However, dealing with each customer by revamping firmware requires long development periods and costs for the devices, and updating firmware also requires high-level maintenance by field engineers and the like. Thus, it can be said that this approach is problematic in cost-effectiveness if prompt handling of the demands of each customer is to be achieved.

With an MFP having a software operating environment such as a Java platform, for example, built into an embedded system's firmware, new device-embedded applications independent of the firmware, can be developed on the software operating environment, and the print functions of the device can be accessed from Java applications via APIs. The Java platform, however, is situated in the embedded application layer within the firmware. Accordingly, it has not been possible to adapt print data reception functions or print server functions achieved as native embedded applications in the same layer as the Java platform to Java applications. That is to say, print server functions having the various types of print service protocols for receiving print data via the network for example have to be provided to the Java side as well, which is an inefficient arrangement from the perspectives of expenditure of resources for development, evaluation, and memory capacity at the time of execution thereof.

On the other hand, if there is no software operating environment layer within the firmware of an embedded system, the entire embedded system possesses a configuration capable of dynamic linking and plug-ins, and thus, the entire system possesses a dynamic configuration. This is unsuitable for a low-cost, small-scale system, taking into consideration the concept that the only component for which dynamic properties are required is the configuration for flexibly and expandably adding pre-processing that is executed prior to interpreting a received PDL data stream. The reason is that overhead costs and difficulty are increased with regard to ensuring quality when configuring the entire system as dynamic software.

Accordingly, the present assignee has proposed in Japanese Patent Laid-Open No. 2004-093215 to provide a filter portion for performing pre-processing prior to interpreting a received PDL data stream as flexible and expandable software, separately from the other components of the printer firmware. This is a proposal for improving productivity in customization of PDL printers, by clearly separating the implementation of the expandable software of this filter component from implementation of other components of the printer firmware for which stability is required.

With the above proposal, however, there is the need to constantly perform filtering processing on the whole of all print request data streams, and, accordingly, efficient processing is not achieved thereby. For example, a print request data stream which an image processing device receives constitutes a device control data stream portion and a rendering data stream portion, and with this arrangement, filtering processing is performed on the entire print request data stream at all times, i.e., on both data stream portions, so the overall processing is slow, resulting in such problems as reduced throughput, meaning that efficient processing cannot be performed. Furthermore, consideration has not been given to handling various print processing request data streams other than PDLs, including but not limited to temporarily holding processing of data in the image processing device, or transmitting image data read with the image processing device via e-mail.

Accordingly, in an effort to realize more effective processing, the present assignee has filed Japanese Patent Application No. 2004-231433. Japanese Patent Application No. 2004-231433 proposes an assembly wherein individual data stream components such as the device control data stream portion and the rendering data stream portion can be filtered. The device control stream component constitutes an instruction command primarily relating to control of the device, including but not limited to using Job Language (JL) to specify the paper feed cassette or discharge tray. Also, the rendering data stream component, which may include, but is not limited to, Page Description Language (PDL), constitutes instruction commands relating to rendering.

Japanese Patent Application No. 2004-231433 proposes an assembly for performing optimal filtering on various types of intermediate data streams such as the device control data stream component and the rendering data stream component within the image processing device, as derived from the print request data stream. With Japanese Patent Application No. 2004-231433, however, each data stream is processed independently, and each filter independently determines whether or not to apply filtering to a data stream. That is to say, consideration has not been given to an operation wherein application of filtering processing on one data stream is determined according to the contents of another data stream. For example, control cannot be performed wherein filtering processing is applied to the rendering data stream (PDL) depending on the job type and the PDL type described in the device control data stream (JL).

### DISCLOSURE OF INVENTION

The present invention provides for allowing control regarding whether or not to apply filtering processing based on a description within a data stream, thereby achieving efficient data stream processing.

With a data processing apparatus having an interpreter environment for dynamically executing programs that are built based on a command set independently defined from a native command group within a native environment, input data streams are divided into multiple stages and interpreted within the native environment, with intermediate data streams being generated for each state, and within the interpreter environment, the intermediate data streams are subjected to filtering processing and filtered data streams are generated. Handing over of the intermediate data streams to filters is performed via a layer interface. A data stream management attribute module extracts information for items specified beforehand from an intermediate data stream, and controls handing over of the intermediate data stream to the filter, based on the contents of this information.

According to the first aspect of the present invention, there is provided an information processing apparatus having, in a native environment configured based on a first command group processed by a processor which constitutes hardware, an interpreter environment for dynamically executing a program configured based on a second command group defined independently from the first command group, the apparatus comprising: data stream reception means for receiving an input data stream including a processing request from a client in the native environment; data processing means dividing the input data stream into a plurality of stages and generating an intermediate data stream at each stage in the native environment; filter means for generating a filtered data stream by filtering an intermediate data stream generated by the data processing means in the interpreter environment; interface means for extracting and writing back, from and to the filter means, an intermediate data stream generated by the data processing means, in the native environment; filter management means for handing off an intermediate data stream generated by the data processing means to the filter means via the interface means, and taking out the filtered data stream via the interface means, in the native environment; and control means for controlling execution of handing over an intermediate data stream by the filter management means to the filter means based on the contents of information of an item specified beforehand contained in the input data stream, in the native environment.

According to the second aspect of the present invention, there is provided a control method of an information processing apparatus having, in a native environment configured based on a first command group processed by a processor which constitutes hardware, an interpreter environment for dynamically executing a program configured based on a second command group defined independently from the first command group, the method comprising: a data stream reception step of receiving an input data stream including a processing request from a client in the native environment; a data processing step of dividing the input data stream into a plurality of stages and generating an intermediate data stream at each stage interpreted in the native environment; a filter step of generating a filtered data stream by filtering an intermediate data stream generated in the data processing step in the interpreter environment; an interface step of extracting and writing back, from and to the filter step, an intermediate data stream generated in the data processing step, in the native environment; a filter management step of handing off an intermediate data stream generated in the data processing step to the filter step via the interface step, and taking out the filtered data stream via the interface step, in the native environment; and a control step of controlling execution of handing off an intermediate data stream by the filter management step to the filter step based on the contents of information of an item specified beforehand contained in the input data stream, in the native environment.

Further features of the present invention will become apparent from the following description of exemplary embodiments, with reference to the attached drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 is a block diagram for describing the hardware configuration of an image processing apparatus according to a first embodiment of the present invention.

FIG. 2 is a hierarchical diagram for describing the software configuration of a controller, according to the first embodiment.

FIG. 3 is a diagram illustrating the basic flow of data between the software modules in the controller, and data streams between the modules thereof, according to the first embodiment.

FIG. 4 is a diagram illustrating the basic flow of data between the software modules in the controller, and data flow at the time of filter processing, according to the first embodiment.

FIG. 5 is a diagram for describing classes in a filter framework configured in the interpreter environment according to the first embodiment.

FIGS. 6A and 6B illustrate an instance of objects managed by a filter framework 219 configured in the interpreter environment of the first embodiment, with FIG. 6A illustrating the relation between objects managed by the filter framework runtime when one filter is in a valid state, and FIG. 6B illustrating the relation between objects managed by the filter framework runtime when two filters are in a valid state.

FIGS. 7A to 7C are diagrams for describing an example of a user interface for operating the filter framework according to the first embodiment.

FIG. 8 is a flowchart illustrating the principal procedures in the filter processing according to the first embodiment.

FIG. 9 is a flowchart illustrating another example of filter processing according to the first embodiment.

FIG. 10 is a diagram for describing a process request data stream according to the first embodiment.

FIG. 11 is a diagram for describing processing which a filter performs with regard to a rendering data stream according to the first embodiment.

FIG. 12 is a diagram for describing filter processing which a filter performs with regard to a rendering data stream according to the first embodiment.

FIG. 13 is a diagram for describing filter processing which an optimization filter performs with regard to a rendering data stream according to the first embodiment.

FIG. 14 is a diagram for describing processing which a function-adding filter performs with regard to a device control instruction data stream according to the first embodiment.

FIG. 15 is a diagram illustrating an example of a user interface for operating a function extension filter.

FIG. 16 is a diagram for describing a transmission data stream according to a second embodiment of the present invention.

FIG. 17 is a flowchart illustrating processing for determining whether or not to apply filtering via a data stream attribute management module according to the second embodiment.

FIG. 18 is a diagram for illustrating an example of a user interface for configuring filter application conditions.

### BEST MODE FOR CARRYING OUT THE INVENTION

Preferred embodiments of the present invention will now be described in detail in accordance with the accompanying drawings.

### First Embodiment

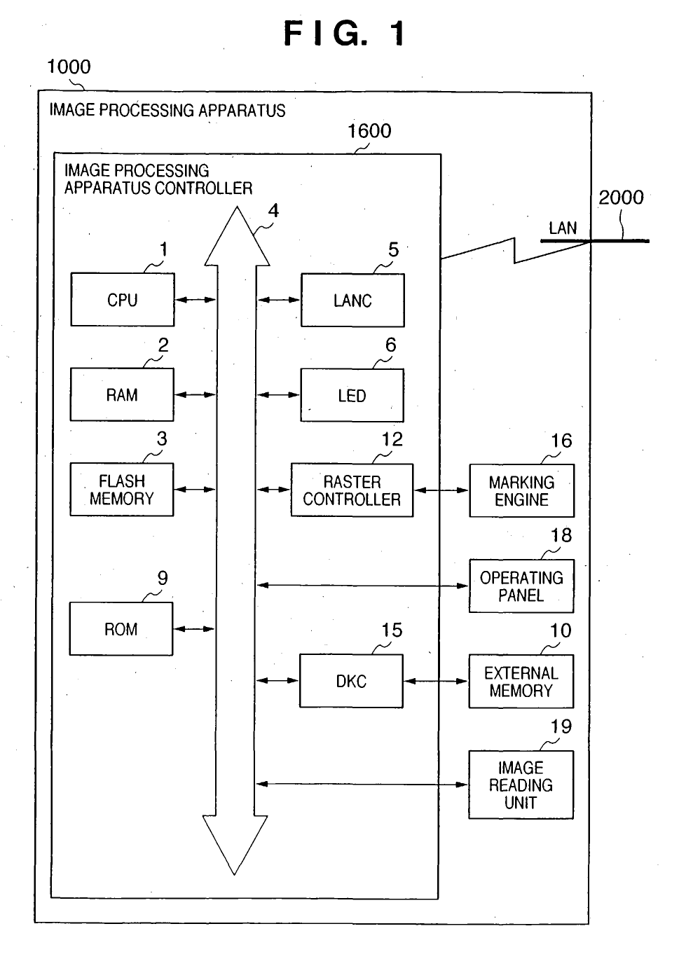

FIG. 1 is a block diagram describing the hardware configuration of an image processing apparatus 1000 according to the present embodiment. This image processing device 1000 has an image processing apparatus controller 1600 (hereinafter, referred to as controller 1600) and is constituted of a device which governs a different control system. It is presumed that the particular image processing apparatus 1000 according to the embodiment is a printing apparatus.

A CPU 1 executes control operations in accordance with a control program stored in a rewritable flash memory 3 (hereinafter, referred to as non-volatile memory 3). The CPU 1 also centrally controls various types of data transmission/reception requests, including but not limited to printing data or printer control commands, which are transmitted from a plurality of external devices (not shown), including but not limited to a host computer, that are connected to a local area network (LAN 2000). Communication with external devices connected to the LAN 2000 is preformed via a network controller (LANC) 5 connected to a system bus 4, using a predetermined network communication protocol. The CPU 1 centrally controls access to the various devices connected to the system bus 4. This control is carried out according to either control programs or the like stored in a ROM 9, or control programs or resource data or the like stored in an external memory 10, which is connected via a disk controller (DKC) 15. Accordingly, image information is generated by a raster controller 12, in accordance with the received printing data, and the image information is output to a marking engine (printer engine) 16.

A RAM 2 is used as a temporary storage region such as main memory, work area, etc., for the CPU 1. The flash memory 3 is rewritable non-volatile memory, and stores control programs together with the ROM 9. The system bus 4 is used for exchanging data among the devices that make up the controller 1600.

The network controller (LANC) 5 connects the controller 1600 to the LAN 2000. An LED 6 is used as a display unit for indicating the operating status of the controller 1600. For example, the LED 6 can be used to represent various operating statuses, such as the electrical connection state (LINK) between the LANC 5 and the LAN 2000, network communication mode, which may include, but is not limited to, 10Base or 100Base, full duplex or half duplex, by way of blinking patterns or color, or the like, of the LED 6. The external memory 10 has control programs and various types of data, and is connected to the controller 1600 via the DKC 15. Generally, hard drives, USB memory, or the like, are used as the external memory 10. The raster controller 12 generates image information to be output, based on the received printing data. The marking engine 16 receives image information from the raster controller 12, and performs printing.

An operating panel (operating unit) 18 has arrayed thereupon buttons for setting operating modes of the image processing device 1000, canceling printing data, and so forth, and a display unit having a liquid crystal panel, or LEDs, or the like, for indicating the operating status of the image processing device 1000. A touch panel is provided to the operating unit 18, overlaid on the liquid crystal panel. An image reading unit 19 inputs read (scanned) image information to the image processing device 1000 by an instruction for reading image information being made thereto from the operating panel 18 or the local area network 2000.

The marking engine 16 shown in FIG. 1 uses known printing techniques, preferable examples thereof including, but not being limited to, electrophotography (laser beam printing), ink jet printing, or sublimation (thermal transfer) printing.

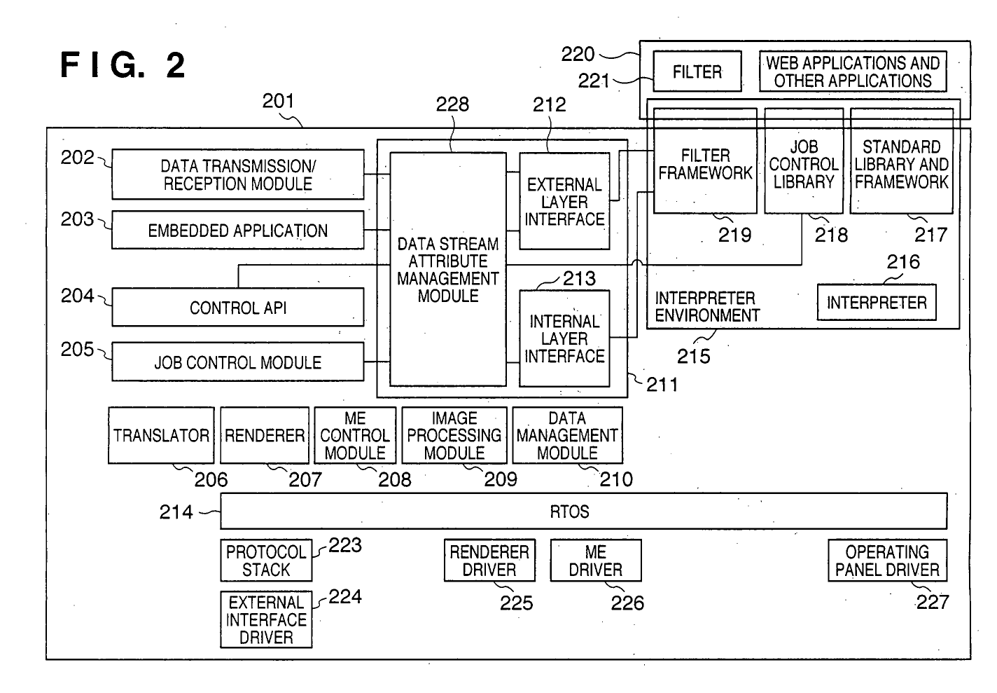

FIG. 2 is a hierarchical diagram illustrating the software structure of the controller 1600 according to the embodiment. The diagram illustrates how the higher-level modules situated toward the top are dependent oh the lower-level modules situated toward the bottom. Lines which connect modules indicate a particular dependent relationship.

A native code unit 201 is a standard component that makes up the firmware of the image processing apparatus 1000, and is directly executed by the CPU 1, i.e., is executed in the native environment. The native code unit 201 is statically linked to a single load module when the device is developed, and is stored as a firmware in the non-volatile memory 3 of the image processing apparatus 1000. When the image processing apparatus 1000 is activated, the firmware is loaded from the non-volatile memory 3 to the RAM 2, and the CPU 1 sequentially reads out code from the RAM 2 and interprets the code and executes the processing thereof, while the image processing apparatus 1000 is running. No dynamic linking is performed when executing the processing, however. An arrangement may also be made wherein the firmware is stored in non-volatile memory which the CPU 1 can directly access by reading, as with the ROM 9, so that the CPU 1 can sequentially read out, interpret, and execute the code from the ROM 9 without rendering in the RAM 2.

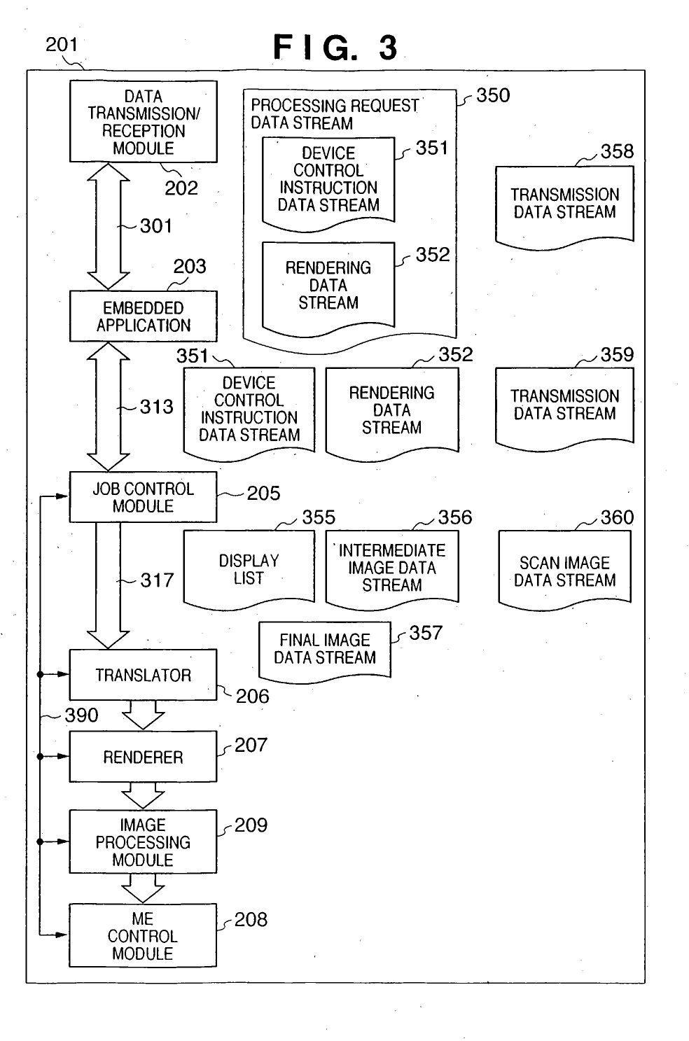

A data transmission/reception module 202 receives a processing request data stream 350 (FIG. 3) from a client as an input data stream, and transmits a transmission data stream 358 (FIG. 3), that is generated within the controller 1600, to the client. The data transmission/reception module 202 is dependent on a protocol stack 223 via a real-time operating system (RTOS) 214. Transmission and reception of data between the data transmission/reception module 202 and the client is physically performed via networks such as Ethernet, or various interfaces such as USB or IEEE1394. Application protocols for performing processing requests according to each connection arrangement are stipulated. The data transmission/reception module 202 is provided with application protocol server functions. There are various specifications for service application protocols, and network protocols alone include various types such as LPR, SMB, PAP, and NetWare. The achievement thereof incurs massive costs in development and quality evaluation. The data transmission/reception module 202 provides multi-protocol support, which derives from the various types of service protocols that exist for each of the plurality of interfaces. The data transmission/reception module 202 may be arranged to form a job queue in the RAM 2 of the image processing apparatus 1000 for transmission/reception of data, such that it is provided with a spooling function, as it were. In such an instance, the data transmission/reception module 202 accepts the job request from the client, stores the job in the queue, and releases the client, even if a job cannot be executed immediately, such as when executing another job. Thus, the job is processed in order according to a scheduling algorithm, when it becomes possible to execute the job.

An embedded application 203 is an embedded application for providing the central functions of the image processing apparatus 1000, and provides service in response to client requests. In the event that the client is application and driver software on a host connected via the LAN 2000, the client generates a processing request data stream 350 (FIG. 3), which it hands off to the embedded application 203 via the data transmission/reception module 202. The embedded application 203 divides the processing request data stream 350 into a device control instruction data stream 351 (FIG. 3) and a rendering data stream 352 (FIG. 3), and hands each stream off to a job control module 205, via a control API 204. Alternatively, the embedded application 203 interprets the device control instruction data stream 351, directs the job control module 205 to carry out the processing requested by the client via the control API 204, and hands off the rendering data stream 352 (FIG. 3) to the job control module 205 via the control API 204.

For example, if the client is an instruction made by way of the operating panel 18 of the image processing apparatus 1000, the device control instruction data stream 351 (FIG. 3) is generated by the embedded application 203, and handed to the job control module 205 via the control API 204. Alternatively, the instruction requested from the client is given to the job control module 205 by the control API 204. This description portion relating to device control is typically referred to as Job Language (JL. The JL includes, but is not limited to, environment data for interpreting rendering data and specifying operation parameters for a rendering system, specifying paper feed for transfer paper used for printouts, configuring printing modes such as duplex printing, specifying discharge trays, specifying sorting (collating), and specifying finishing, such as stapling and bookbinding. On the other hand, the rendering data stream is described in a PDL, which mainly describes rendering in increments of pages.

The control API 204 is an application programming interface for accessing services which the image processing apparatus 1000 provides. The following are two primary interfaces that constitute the control API 204. One is an interface for executing and controlling print jobs, and the other is an interface for handing the device control instruction data streams 351 (FIG. 3) and rendering data streams 352 (FIG. 3) off to the job control module 205.

The job control module 205 controls various types of image processing jobs which the image processing apparatus 1000 provides. Print job processing, which is an example of an image processing job, will now be described.

The job control module 205 performs apparatus control according to instructions given via the control API 204. Alternatively, the job control module 205 operates by interpreting a device control instruction data stream 351 (FIG. 3) input thereto via the control API 204. The job control module 205 controls a translator 206, a renderer 207, an ME control module 208, an image processing module 209, and a data management module 210, in response to an instruction regarding control of the apparatus via the control API 204, or according to the contents described in the device control instruction data stream 351. In the event of a print job, the rendering data stream 352 (FIG. 3) is converted into a display list 355 (FIG. 3) by the translator 206. The display list 355 (FIG. 3) is further converted into an intermediate image data stream 356 (FIG. 3) by the renderer 207. This intermediate image data stream 356 is then converted into a final image data stream 357 (FIG. 3) by the image processing module 209, and the final image data stream 357 is sent to the ME control module 208 and scheduled for printing.

As a further example, description will be made regarding the image data reading and transmitting operations provided by the embedded application 203. If an instruction has been issued from the operating panel 18 to read and transmit image data, the embedded application 203 issues an image data read and transmission instruction to the job control module 205, via the control API 204. This transmission instruction is executed by the embedded application 203 directly instructing the job control module 205 via the control API 204. Alternatively, this is executed by the embedded application 203 generating a device control instruction data stream 351, which the embedded application 203 hands off to the job control module 205 via the control API 204. The job control module 205 inputs the image data from the image reading unit 19, stores the image data in the RAM 2, and hands it off to the image processing module 209. The scan image data stream 360 (FIG. 3) thus generated is scheduled to be handed off to the embedded application 203. The embedded application 203 converts the scan image data stream 360 which has been handed off thereto into a format directed by the operating panel 18 so as to generate a transmission data stream 359 (FIG. 3), which is transmitted via the data transmission/reception module 202. Alternatively, if the transmission destination directed by the operating panel 18 is the built-in external memory 10, the embedded application 203 instructs the job control module 205, via the control API 204, to read and save the image data. The instruction is executed by the embedded application 203 directly instructing the job control module 205, via the control API 204. Alternatively, the instruction is executed by the embedded application 203 generating a device control instruction data stream 351 and handing it off to the job control module 205 via the control API 204. The job control module 205 inputs the image data from the image reading unit 19, stores it in the RAM 2, and hands it off to the image processing module 209. The scan image data stream 360 (FIG. 3) generated by the image processing module 209 is then scheduled for storage in the external memory 10 via the data management module 210.

The translator 206 interprets a rendering data stream 352, such as PDL, and converts it into an intermediate printing language suitable for rendering processing. The description of print data by way of an intermediate printing language suitable for rendering processing is called a display list 355 (FIG. 3). The translator 206 has various unique implementations for each of the various types of PDL specifications, and each translator converts its respective PDL into a display list 355 that is unique to the renderer 207.

The renderer 207 renders the display list 355 into an intermediate image data stream 356 (FIG. 3). The renderer 207 is dependent on a renderer driver 225 via the RTOS 214.

The marking engine (ME) control module 208 controls the marking engine 16 which performs image formation onto a transfer paper in the image processing apparatus 1000. The ME control module 208 is dependent on an ME driver 226 via the RTOS 214.

The image processing module 209 performs various types of image processing on the intermediate image data stream 356 of the image processing apparatus 1000, including but not limited to half-toning, trapping, density correction, or color/monochrome conversion.

The data management module 210 saves and manages data streams, such as the intermediate image data stream 356 (FIG. 3) of the image processing apparatus 1000 and the final image data stream 357 (FIG. 3), in the external memory 10. An arrangement may be made wherein data streams other than image data streams may be saved and managed. A layer interface 211 exchanges data streams with the interpreter environment 215, within the image processing apparatus 1000. The layer interface 211 is typically divided into the internal layer interface 213 and the external layer interface 212, in order to assign levels to data streams pertaining to filtering processing.

The external layer interface 212 hands off the processing request data stream 350, the device control instruction data stream 351, the rendering data stream 352, and the transmission data streams 358 and 359, from the data transmission/reception module 202 and the embedded application 203, to the interpreter environment 215. The external layer interface 212 hands off each data stream processed at the filter 221 to the data transmission/reception module 202, the embedded application 203, and the job control module 205.

The internal layer interface 213 hands off the display list 355, the intermediate image data stream 356, the final image data stream 357, and the scan image data stream 360, which are generated by the job control module 205, to the interpreter environment 215. The job control module 205 generates the lists and data streams by interacting with the translator 206, the renderer 207, the ME control module 208, the image processing module 209, the data management module 210, and the image reading unit 19. The internal layer interface 213 hands off the job processed by the filter 221 to the job control module 205. It goes without saying that the exchange of data streams may be carried out between the translator 206, the renderer 207, the ME control module 208, the image processing module 209, the data management module 210, the image reading unit 19, and the interpreter environment 215, as opposed to only the job control module 205.

The RTOS 214 is a platform that provides an execution environment for the image processing apparatus 1000's native code firmware. The RTOS 214 provides basic services to be used for the building of software, together with services of abstracted hardware resources of the apparatus 1000, for software running thereupon, as well as a device driver architecture framework for abstracting the hardware of the apparatus 1000 into interfaces that are readily used by the software. The functions provided by the RTOS 214 include, but are not limited to, task management wherein a command execution context by the CPU 1 is abstracted, and a multitasking mechanism for achieving concurrent processing wherein multiple execution contexts are simultaneously operated in a virtual manner. Further functions which the RTOS 214 provides include, but are not limited to, exchanging messages among tasks, inter-task communication, i.e., message queues, semaphore, etc. for synchronization, managing various types of memory, timers, and clocks, interruption management, and DMA control. Note that a semaphore is a mechanism whereby processes operating concurrently are synchronized and interruption processing is controlled, among other functions.

The interpreter environment 215 is a software platform configured by adding API groups and framework groups unique to the image processing apparatus 1000 thereto, based on the various types of interpreter environments, in this case the Java platform runtime environment. This software platform provides a dynamic software operating environment for programs described in interpreter languages of interpreters running thereupon. The interpreter environment includes a portion that is implemented by native code, included in the native code unit 201, and portions implemented as programs described in the interpreter language, included in interpreter code unit 220 shown in FIG. 2).

The interpreter 216 sequentially reads out commands from a command string described with a predetermined command set, which it then interprets and executes. The interpreter 216 constitutes a Java virtual machine, and the command set is Java byte code.

The standard API library and framework group 217 further abstracts various types of abstracted computing resources provided by the RTOS 214, using a module unique to the interpreter environment, thereby providing an execution environment for the programs running on the RTOS 214. In this case, the abstraction is achieved by the standard class library group making up the Java platform, and an Open Services Gateway initiative (OSGi) framework, used here to mean compliance with OSGi standards. The Java platform provides abstracted functions equivalent to the RTOS 214. Functions provided might include, but would not be limited to, thread management wherein command execution contexts are abstracted by the virtual machine, multithreading mechanisms for simultaneously running multiple execution contexts in a virtual manner to achieve concurrent processing, thread communication for exchanging messages among threads and for synchronization, management of various types of memory that have been highly abstracted, such as collections, as well as timers and clocks, exception management, access to file systems and networks, and interfacing with external input/output devices. The OSGi framework runs multiple Java applications, or services, on a single Java virtual machine. The OSGi framework also provides such functions as application lifecycle management and communication functions between applications. A plurality of system services are pre-installed on the OSGi framework. The system services include:

service management services for adding new applications to the interpreter environment, and updating or deleting existing applications;
applet view services for enabling operations of a Java class implemented by an applet interface from the operating panel 18, by displaying the Java class on the operating panel of the image processing apparatus; and
HTTP services for running a Java class implemented by a servlet interface as a Web application operable from a client browser.

In particular, Java applications implemented by an applet interface can be interfaced indirectly with the operating panel driver 227, via an API of the Abstract Window Toolkit (AWT).

The job control library 218 is dependent on the control API 204, and provides an application programming interface enabling execution and control of image processing jobs for programs running on the interpreter environment.

The filter framework 219 communicates with the embedded application 203 to enable interposition vis-a-vis a plurality of data streams of the image processing apparatus 1000 from the filter program implemented on the interpreter environment when a job is executed.

The interpreter code unit 220 is implemented as software described in an interpreter language which the interpreter 216 can interpret, and includes a part of the API library group and framework group making up the interpreter environment, as well as programs running in the interpreter environment. The software situated as straddling the native code unit 201 and the interpreter code unit 220 requires that modules interfacing between these spaces be coded in accordance with a unique framework and a unique programming module that are stipulated by the interpreter environment. In this case, the boundary portion programming is performed in accordance with a Java Native Interface (JNI).

The filter 221 is a program implemented in the interpreter environment, and is implemented according to the framework of the filter framework 219, so as to be capable of processing the processing request data streams processed by the embedded application 203. The protocol stack 223 is embedded into the framework of the RTOS 214, and is provided with protocols at and beneath the transport layer on an external interface controlled by an external interface driver 224 at a lower level. For example, the foregoing achieves protocols such as TCP/IP and UDP/IP when applied to a network interface. The protocol stack 223 also provides an interface to the embedded application 203 for application programming, such as the Berkley sockets API, via the RTOS 214. Also, if the external interface is, for example, USB, protocols such as IEEE 1284.4 and the like are achieved.

The external interface driver 224 drives hardware providing connections to various types of interfaces, including but not limited to network interfaces, IEEE1394, USB, RS232C, and Centronics. With a network, for example, the device activates network interface hardware for connecting to a network such as Ethernet, thereby achieving a physical layer protocol.

The renderer driver 225 drives the renderer 207. The renderer 207 is hardware for rendering the display list 355 shown in FIG. 3 into an intermediate image data stream 356. The renderer 207 may be achieved in software, and the rendered data stream may be a final image data stream 357 (FIG. 3). The ME driver 226 drives a marking engine which performs image formation onto a transfer paper. The operating panel driver 227 processes output to the display unit of the operating panel 18 of the image processing apparatus 1000, as well as input events from keys, the touch panel and the like.

The layer interface 211 has a data stream attribute management module 228. The user can direct the processing content of the data streams in the image processing apparatus 1000 to the data stream attribute management module 228, via the operating panel 18.

Specifically, if the data transmission/reception module 202 receives a processing request data stream 350, the data stream attribute management module 228 starts data stream attribute management corresponding to the processing request data stream 350. Each of the modules under the native environment inquire of the data stream attribute management module 228 as necessary, so as to determine the processing content regarding the data stream. Examples of modules within the native environment in this case include the data transmission/reception module 202, the embedded application 203, and the job control module 205, as well as the translator 206, the renderer 207, the ME control module 208, the image processing module 209, and the data management module 210. The modules also notify the data stream attribute management module 228, in the event that specified information has been extracted. Upon receiving such notification, the data stream attribute management module 228 updates the data stream attributes. Upon receiving a job notification from the job control module 205 to the effect that all processing regarding the processing request data stream 350 has ended, the data stream attribute management module 228 ends management of the data stream attributes for the processing request data stream 350.

Alternatively, if a scan image data stream 360 has been generated by the job control module 205, the data stream attribute management module 228 starts management of the data stream attributes of the scan image data stream 360, and the data stream attributes are managed in a manner similar to the foregoing. Upon receiving a job notification from the job control module 205 to the effect that all processing regarding the scan image data stream 360 has ended, the data stream attribute management module 228 ends management of the data stream attributes for the scan image data stream 360.

As described above, if the data transmission/reception module 202 receives a processing request data stream 350, the data stream attribute management module 228 starts data stream attribute management thereof. The data stream attribute management module 228 discloses the data stream attributes to the modules present in the interpreter environment, via the control API. Doing so facilitates processing regarding the data stream attributes similar to the foregoing, i.e., commencement of management of data stream attributes, inquiry from the modules to the data stream management module, notification from the modules to the data stream management module, updating of data stream attributes by the data stream management module, and ending of data stream attributes management. The data stream attributes also enable such operations as not handing off to the interpreter environment modules at all, for example.

FIG. 3 is a diagram illustrating the basic data flow between the software modules in the controller 1600, and data streams of the respective modules, according to the embodiment. Modules shown in Fig similar to the modules in FIG. 2 are denoted with common reference numerals, and description thereof will be omitted.

The data transmission/reception module 202 sends a processing request data stream 350, received from the client, to the embedded application 203 via a path 301, if no filter 221 interposition is present. The path 301 is achieved by inter-task communication functions including, but not limited to, message queuing provided by the RTOS 214. Other data is handed off in similar fashion. A processing request data stream 350 is made up of a device control instruction data stream 351 and a rendering data stream 352.

If the client is application and driver software on a host connected via the LAN 2000, the client generates a processing request data stream 350. The processing request data stream 350 is then handed off to the embedded application 203 via the data transmission/reception module 202. The embedded application 203 divides the processing request data stream 350 into a device control instruction data stream 351 and a rendering data stream 352, and hands off each to the job control module 205 via the control API 204. Alternatively, the embedded application 203 interprets the device control instruction data stream 351, directs the processing requested by the client to the job control module 205, and hands off the rendering data stream 352 to the job control module 205 via the control API 204.

On the other hand, if the client is an instruction made by the client by way of the operating panel 18 of the image processing apparatus 1000, the device control instruction data stream 351 is generated by the embedded application 203, and handed off to the job control module 205 via the control API 204. Alternatively, the instruction requested from the client is given to the job control module 205 by the control API 204. This description portion relating to device control is generally called Job Language (JL). The JL includes, but is not limited to, environment data for interpreting rendering data and specifying operation parameters for a rendering system, specifying paper feed cassette of transfer paper used for printouts, configuring such printing modes as duplex printing, specifying discharge trays, specifying sorting (collating), and specifying finishing such as stapling and bookbinding. On the other hand, the rendering data stream is described in a PDL, which mainly describes rendering in increments of pages.

The job control module 205 performs control of the apparatus 1000 following instructions delivered via the control API 204. Alternatively, the job control module 205 interprets a device control instruction data stream 351 input thereto via the control API 204, and operates accordingly. In response to instructions regarding control of the apparatus 1000 that are issued via the control API 204, or content listed in the device control instruction data stream 351, the job control module 205 controls the translator 206, the renderer 207, the ME control module 208, the image processing module 209, and the data management module 210, via a control line 390. In the event of a print job, the job control module 205 performs scheduling as follows. That is to say, the translator 206 converts the rendering data stream 352 into a display list 355, and the renderer 207 converts the display list 355 into an intermediate image data stream 356. The intermediate image data stream 356 is then converted by the image processing module 209 into a final image data stream 357, and the final image data stream 357 is sent to the ME control module 208 and is printed.

Operations when reading and transmitting image data provided from the embedded application 203 will be illustrated as a further example. If an image data read and transmission instruction is issued from the operating panel 18, the embedded application 203 performs instruction for image data reading and transmission to the job control module 205, via the control API 204. The instruction is transmitted directly to the job control module 205 from the embedded application 203 via the control API 204, and is executed. Alternatively, this instruction is achieved by the embedded application 203 generating a device control instruction data stream 351 and handing it off to the job control module 205, via the control API 204. The job control module 205 inputs the image data read by the image reading unit 19, maintains the inputted image data in the RAM 2, and hands it off to the image processing module 209. Thus, scheduling is performed so as to hand off the scan image data stream 360 generated by the image processing module 209 to the embedded application 203. The embedded application 203 converts the scan image data stream 360 that has been handed off, into the format instructed from the operating panel 18, thereby generating a transmission data stream 359. The transmission data stream 359 is then transmitted as a transmission data stream 359 from the data transmission/reception module 202. Alternatively, if the destination directed from the operating panel 18 is the built-in external memory 10, the embedded application 203 instructs the job control module 205, via the control API 204, to read and save the image data. This instruction is executed by the embedded application 203 directly instructing the job control module 205, via the control API 204. Alternatively, the execution is carried out by the embedded application 203 generating a device control instruction data stream 351, and handing off the device control instruction data stream 351 to the job control module 205, via the control API 204. The job control module 205 inputs the image data from the image reading unit 19, via the control line 390, stores it in the RAM 2, and hands it off to the image processing module 209. The scan image data stream 360 thus generated is scheduled for storage in the external memory 10, via the data management module 210. All of the processing described so far is implemented in the native code unit 201.

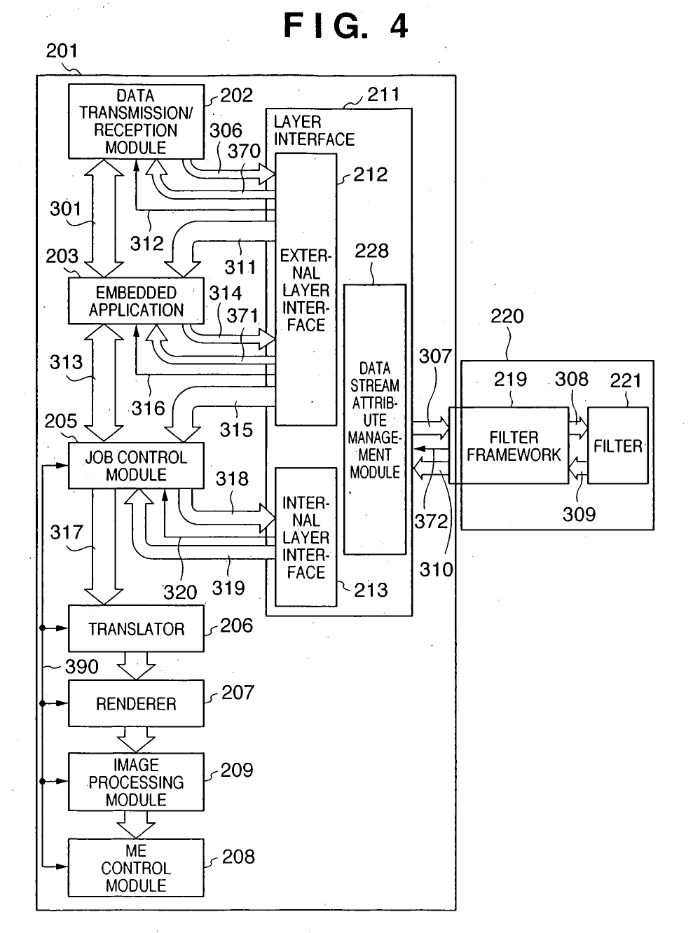

FIG. 4 is a diagram for describing the basic flow of data between software modules in the controller 1600, and data flows at the time of filter processing, according to the embodiment. The data streams in the modules shown in FIG. 4 are similar to the corresponding elements shown in FIG. 3, and the portions which are in common with the preceding drawings are denoted with identical reference numerals.

If a data stream is subjected to filtering processing, the data transmission/reception module 202 sends a processed data stream to the external layer interface 212, via the path 306. The handoff is achieved by inter-task communication functions which may include, but are not limited to, message queuing and the like provided by the RTOS 214, although other data handoff procedures may be used to this end as well. The external layer interface 212 within the layer interface 211 hands off the various data streams to the interpreter environment 215. Examples of data streams include the processing request data stream 350 which is a data stream received externally from the image processing apparatus 1000 via the LAN 2000 or the like, the device control instruction data stream 351 and the rendering data stream 352 which are obtained by dividing the processing request data stream 350 within the image processing apparatus 1000, the transmission data stream 359 which is obtained by conversion and generation executed by the embedded application 203, and the transmission data stream 358 which is subjected to final transmission processing by the data transmission/reception module 202, and so forth. The data streams may have been retrieved from the external memory 10 by the data management module 210.

The external layer interface 212 sends the received data stream to the filter framework 219 via a path 307. The runtime module of the filter framework 219 manages the filter 221, which is a filer program group, provided within the interpreter environment 215. The filter framework 219 sends the data stream to the filter 221 via a path 308. The handoff is achieved on the path 308 by inter-thread communication functions that are provided by the interpreter environment 215, for example. The same applies to the exchange of data within the interpreter environment 215. If multiple filters 221 are provided, the data streams flow between each of the filters, with the handoff achieved by inter-thread communication functions provided by the interpreter environment 215. A runtime module refers to a software module that is required when a program is executed.

The filter 221 subjects a data stream received as input to predetermined processing, and outputs the result. The data stream that is outputted by the filter 221 is sent to the filter framework 219 via a path 309. The filter framework 219 hands off the data stream received from the filter 221 to the external layer interface 212, via a path 310. Thus, the external layer interface 212 sends the data stream to the embedded application 203 via a path 311. Alternatively, an arrangement may be made wherein the external layer interface 212 sends the data stream to the data transmission/reception module 202 via a path 370, from which the data stream is sent to the embedded application 203 via the path 301, as described above.

Control paths 312 and 372 are paths for controlling data streams from the data transmission/reception module 202 to the embedded application 203, depending on the state of the filter framework 219. If the filter 221 which the filter framework 219 manages is installed in a valid state, the paths 306 and 307 are valid, and pre-processing by the filter 221 is performed. If the filter framework 219 does not have a valid filter 221 installed, the path 301 is valid, and the data stream flows directly from the data transmission/reception module 202 to the embedded application 203. In this case, the overhead due to interposition of the filter framework 219 can be avoided, and the data processing capabilities of the image processing apparatus 1000 are manifested in a standard state wherein no customization by the filter 221 is performed at all.

If the embedded application 203 subjects the data stream to filtering processing, the data stream flows to the external layer interface 212 via the path 314. over the handoff is achieved by inter-task communication functions which may include, but are not limited to, message queuing and the like provided by the RTOS 214, which also applies to other data handoffs. As described above, in the layer interface 211, the external layer interface 212 in particular hands off, to the interpreter environment 215, the processing request data stream 350 which is essentially a data stream received externally from the image processing apparatus 1000 via the LAN 2000 or the like, the device control instruction data stream 351 and the rendering data stream 352 which are obtained by dividing the processing request data stream 350 within the image processing apparatus 1000, the transmission data stream 359 which is obtained by conversion and generation by the embedded application 203, and the transmission data stream 358 which is subjected to final transmission processing from the data transmission/reception module 202. The data streams may have been retrieved from the external memory 10 by the data management module 210. The external layer interface 212 sends the received data stream to the filter framework 219 via the path 307. The filter framework 219 runtime module manages the filter 221, which is installed in the interpreter environment 215, and the filter framework 219 sends the received data stream to the filter 221 via the path 308. The handoff is achieved on the path 308 by inter-thread communication functions provided by the interpreter environment 215, for example. The same applies to the exchange of data within the interpreter environment 215. If multiple filters 221 are provided, data streams flow between each of the filters, with the handoff achieved by inter-thread communication functions provided by the interpreter environment 215.

The filter 221 subjects a data stream received as input to predetermined processing, and outputs the result. The data stream which the filer 221 outputs is sent to the filter framework 219 via a path 309. The filter framework 219 hands off the data stream received from the filter 221 to the external layer interface 212 via the path 310, and the external layer interface 212 sends the data stream to the job control module 205 via a path 315. Alternatively, an arrangement may be made wherein the external layer interface 212 sends the data stream to the embedded application 203 via a path 371, from where the data stream is sent to the job control module 205 via the path 313 as described above.

The control paths 316 and 372 are paths for controlling data streams from the embedded application 203 to the job control module 205, depending on the state of the filter framework 219. If the filter 221 which the filter framework 219 manages is installed in a valid state, the paths 314 and 307 are valid, and pre-processing by the filter 221 is performed. On the other hand, if the filter framework 219 does not have a valid filter 221 installed, the path 313 is valid, and the data stream flows directly to the job control module 205. In this case, the overhead due to interposition of the filter framework 219 can be avoided, and the data processing capabilities of the image processing apparatus 1000 are manifested in a standard state wherein no customization by the filter 221 is performed at all.

Following is a description regarding a case of the job control module 205 that subjects the data stream to filtering processing. In this case, the data stream flows to the internal layer interface 213 via a path 318. The handoff is achieved by inter-task communication functions, which may include, but are not limited to, message queuing provided by the RTOS 214, and which also applies to other data handoffs. In the layer interface 211, the internal layer interface 213 in particular hands over, to the interpreter environment 215, the display lists and data streams generated by the image processing apparatus 1000. Examples of data handed over by the internal layer interface 213 include a display list 355 which the translator 206 generates by processing a rendering data stream 352, an intermediate image data stream 356 which the renderer 207 generates by processing a display list 355, the final image data stream 357 which the image processing module 209 generates by processing an intermediate image data stream 356, and a scan image data stream 360 that is read in from the image reading unit 19, and so forth. The data streams may have been retrieved from the external memory 10 by the data management module 210. The internal layer interface 213 sends the data stream received via the path 318 to the filter framework 219. The runtime module of the filter framework 219 manages the filter 221 that is installed in the interpreter environment 215. The filtering processing in the interpreter code unit 220 is the same as the above-described processing, and description thereof will be omitted accordingly.

The filter framework 219 hands off the data stream received from the filter 221 to the internal layer interface 213 via the path 310. The internal layer interface 213 sends the data stream to the job control module 205 via a path 319. An arrangement may be made wherein the internal layer interface 213 directly hands off the data stream to the translator 206, the renderer 207, the image processing module 209, the ME control module 208, and the data management module 210.

The control paths 320 and 372 are paths for controlling the data streams, depending on the state of the filter framework 219. If the filter 221 which the filter framework 219 manages is installed in a valid state, the paths 318 and 307 are valid, and pre-processing by the filter 221 is performed. On the other hand, if the filter framework 219 does not have a valid filter 221 installed, the path 317 is valid, and the data stream flows directly to the next module which the job control module 205 has scheduled. In this case, the overhead due to interposition of the filter framework 219 can be avoided, and the data processing capabilities of the image processing apparatus 1000 are manifested in a standard state wherein no customization by the filter 221 is performed at all.

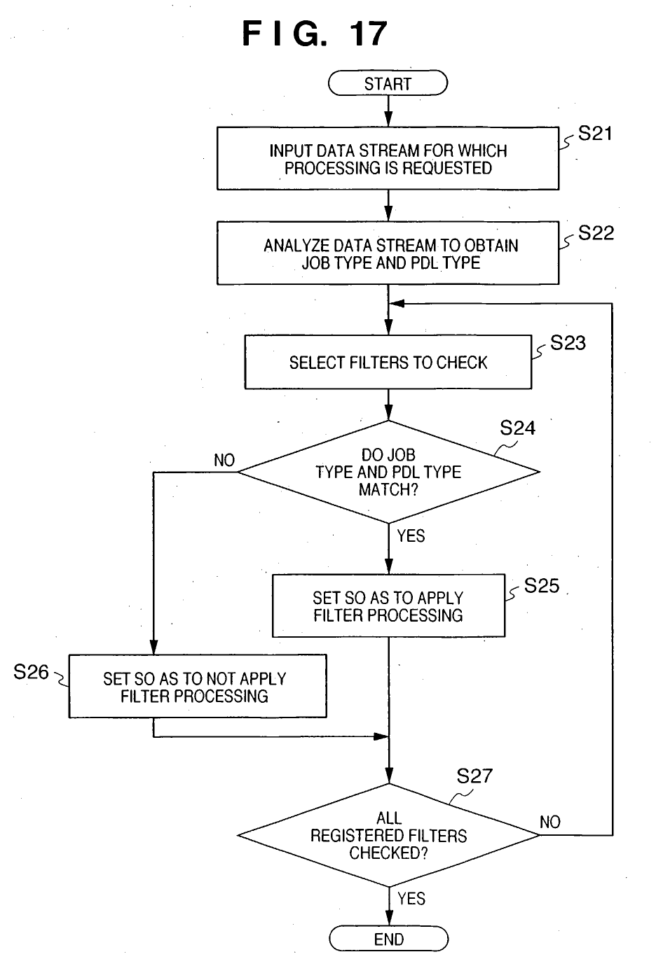

According to the assembly, the data stream attribute management module 228 exists in the native environment of the image processing apparatus, according to the embodiment. The data stream attribute management module 228 executes processing such as that shown in FIG. 17.

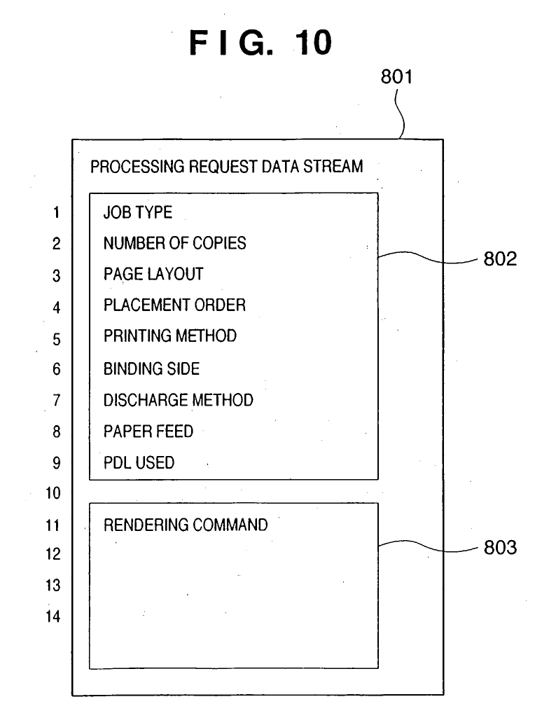

In step S21, the data stream attribute management module 228 commences management of the attributes of the received processing request data stream 350, upon a processing request data stream 350 being input from the data transmission/reception module 202. In step S22, the processing request data stream 350 received in step S21 is analyzed, and the job type and the PDL type of the processing request data stream 350 is determined, based on the device control instruction data stream 351 thereof. The determination is performed based on the “job type” and “PDL used”, as described in the device control instruction data stream 351 in the processing request data stream 801, which is described hereinafter with reference to FIG. 10.

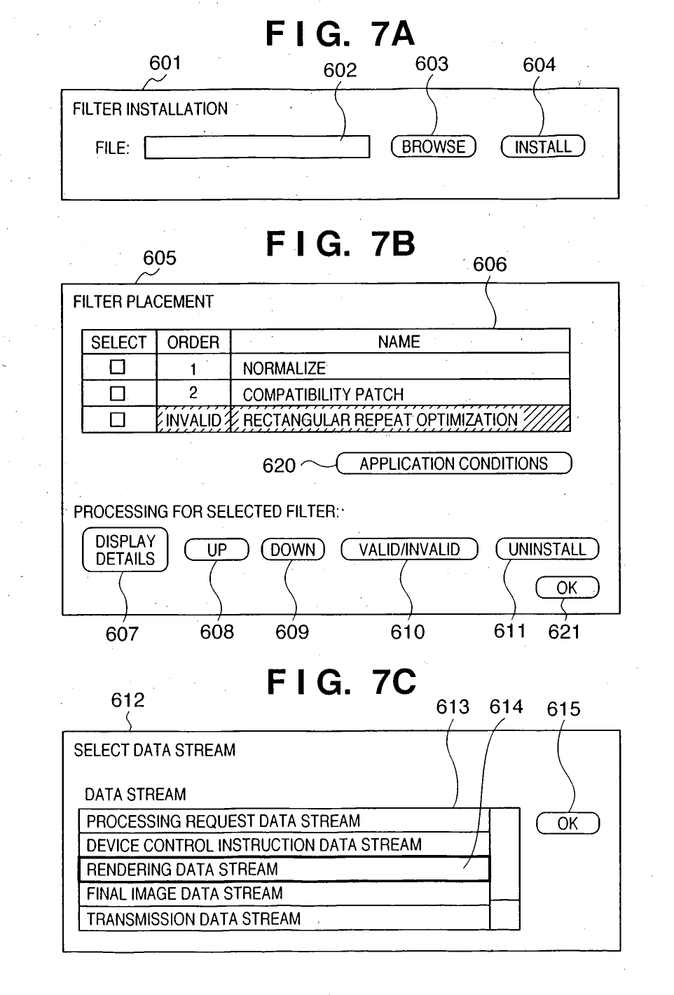

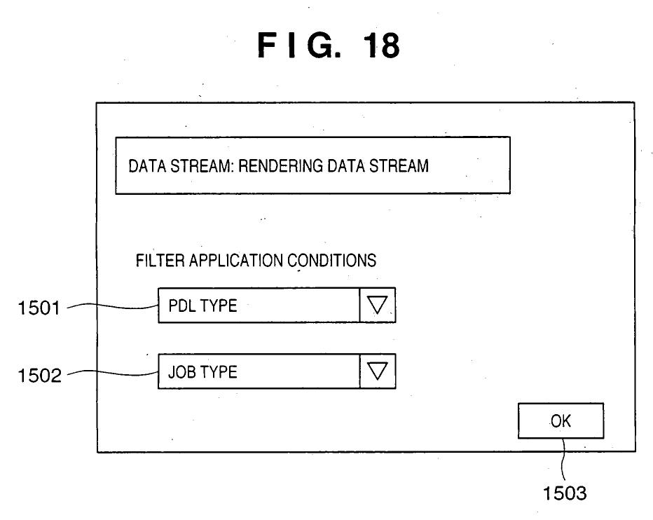

On the other hand, a plurality of filters are registered in the filter 221 according to the embodiment, wherein filters or filter combinations to be applied to processing request data streams or desired intermediate image data streams are set (configured), as described hereinafter with reference to FIG. 7. Moreover, as described hereinafter with reference to FIG. 18, application conditions are set for the filters or the filter combinations. The example shown in FIG. 18 illustrates the way that the PDL type and job type can be configured as conditions for filter application, with regard to a filter or filter combination for rendering the data streams. That is, according to the embodiment, the filters or filter combinations are registered for application to the various types of intermediate data, and the PDL type, the job type, and the like are registered for purposes of determining whether or not to actually apply the filtering processing.

Accordingly, in step S23, the filters or filter combinations to be checked are selected. In step S24, the PDL type and job type described in the input processing request data stream, and the PDL type and the job type set for the registered filters or filter combinations are compared. If the comparison results show a match, then, in step S25, either the embedded application 203 or the job control module 205 is configured such that the filter is applied to the intermediate image data stream. On the other hand, if the comparison results in step S24 show a mismatch, the process proceeds to step S26, and either the embedded application 203 or the job control module 205 is configured such that the transfer of the intermediate image data stream is forbidden. The above processing of steps S23 through S26 is performed for all registered filters (step S27).

In the preceding processing, while the data stream attribute management module 228 has been described as analyzing a processing request data stream and checking for compatibility with the filter application conditions, the embodiment is not restricted to this arrangement. An arrangement may be made wherein an intermediate data stream, e.g., the device control instruction data stream 351, is input, and the data stream is analyzed so as to check for compatibility with the application conditions. With this arrangement, a configuration can be made wherein, for example, a determination as to whether or not the filter functions are to be applied to a rendering data stream 352 is made using the device control instruction data stream 351.

Once such configurations are made to the embedded application 203 or the job control module 205, the embedded application 203 or the job control module 205 operate so as to send to the layer interface 211 only intermediate data streams that are configured for application of filter processing from among the generated intermediate data streams, i.e., the rendering data streams 352 or the display lists 355. Such control prevents unnecessary filtering processing of the intermediate data streams, thereby improving processing efficiency.

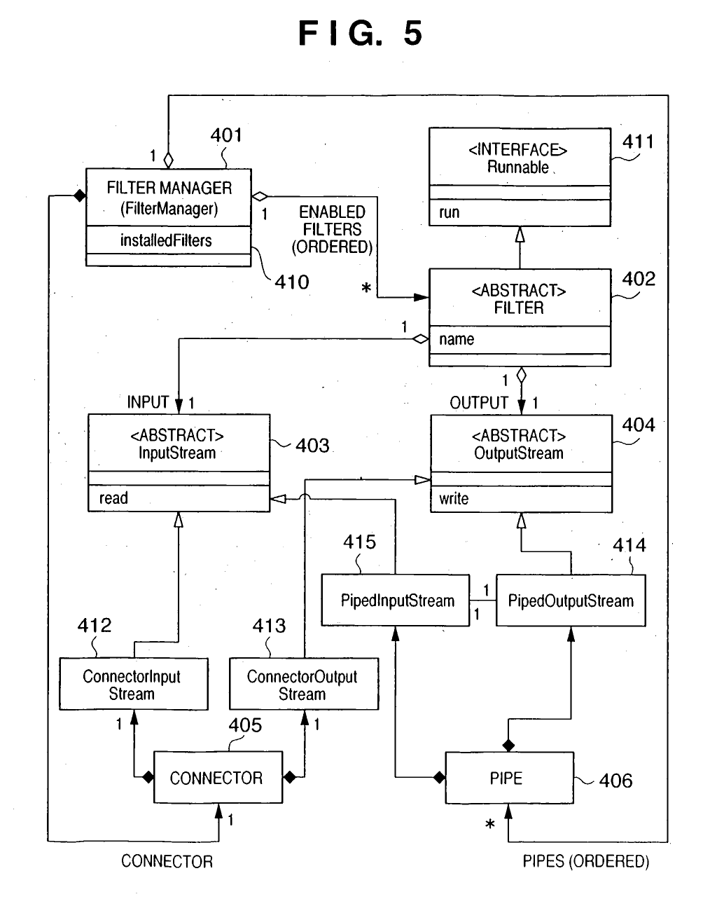

FIG. 5 is a diagram for describing the classes in the filter framework 219 as configured in the interpreter environment 215 according to the embodiment.

A filter manager (FilterManager) class 401 is an object class for achieving the runtime environment of the filter framework 219. The FilterManager class 401 has an object of a single connector (Connector) class 405 as a composition. The FilterManager class 401 also has an ordered list made up of references to a plurality (n) of Filter abstract class 402 objects and a plurality (n−1) of pipe (Pipe) class 406 objects. The FilterManager class 401 further has an installedFilters attribute 410 in the runtime of the filter framework 219 for managing the specific classes of the plurality of Filter abstract classes 402 that have been installed.

The Filter abstract class 402 is an abstract class whereby various types of filter classes are abstracted. The Filter abstract class 402 has such attributes as a name attribute that indicates a file name, as well as references to objects of classes that have inherited an input stream (InputStream) abstract class 403 as input attributes. The Filter abstract class 402 also has references to objects of classes that have inherited an output stream (OutputStream) as output attributes. Specific classes of the Filter abstract class 402 have implemented a Runnable interface 411 to have a run method. Objects of the FilterManager class 401 are placed for filtering processing of a data stream with instances being generated of the various Filter abstract classes 402 that are managed. When this happens, the threads are generated corresponding to the filter objects being placed, and the run method of the filter objects is executed in the execution context of the threads running concurrently. That is, a filter object is handed off to a constructor's parameters, and a Java.lang.Thread object is generated and initiated. Thus, each of the filter objects operates autonomously.

The InputStream abstract class 403 is an abstract class of the input source of the data stream, and has a read method which can sequentially read out data.

The OutputStream abstract class 404 is an abstract class of the output destination of the data stream, and has a write method which can sequentially write data.

The Connector class 405 is a class of objects representing connection for exchanging the data streams between the interpreter environment objects and the native code. The Connector class 405 has, as a composition thereof, objects of a ConnectorInputStream class 412, which is a specific class inheriting the InputStream abstract class 403. The Connector class 405 can sequentially read out the data stream 350 sent from the data transmission/reception module 202 of the native code unit 201, using the read method thereof. The Connector class 405 has, as a composition thereof, objects of a ConnectorOutputStream class 413 inheriting the OutputStream abstract class 404. The data streams sequentially written with the write method of the Connector class 405 are set to the job control module 205 of the native code unit 201 as data streams.

The Pipe class 406 is an object class used for linking among a series of objects of a Filter abstract class 402 when performing a plurality of filtering processes on a data stream. The pipe class has, as compositions thereof, objects of a PipedOutputStream class 414 inheriting the OutputStream abstract class 404, and a PipedInputStream class 415 inheriting the InputStream abstract class 403. The PipedOutputStream object 414 and the PipedInputStream object 415 are connected, thereby achieving inter-thread communication. That is, the filter object writes the data stream sequentially to the PipedOutputStream object of a pipe object using the write method. Doing so allows a separate filter object to sequentially read out the data stream which has been written, using the read method, from the PipedInputStream of the pipe object.

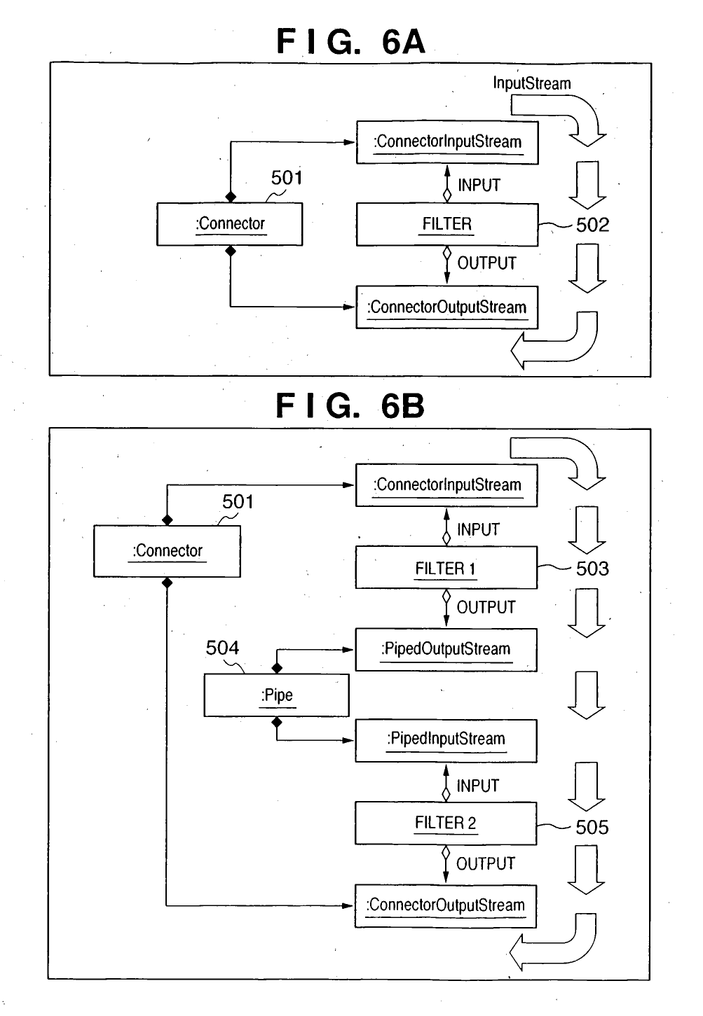

FIGS. 6A and 6B are diagrams illustrating instances of objects managed by the filter framework 219 configured in the interpreter environment 215. FIG. 6A illustrates the relation between objects managed by the runtime of the filter framework 219 in a state wherein one filter is in a valid state.

A connector (Connector) object 501 is a Connector class 405 object. A Filter object 502 is an object of a specific class, a specific form of the Filter abstract class 402. Reference to the ConnectorInputStream object of the Connector object 501 is maintained in the input attributes of the Filter object 502. Attributes of the ConnectorOutputStream of the Connector object 501 are maintained in the output attributes. The Filter object 502 applies filtering processing to a data stream that is read from the ConnectorInputStream object to which “input” points. Thus, a data stream to which filtering processing has been applied is written to the ConnectorOutputStream object to which “output” points. Thus, the handoff of a print data stream (large arrows in the diagram) between objects is achieved.

FIG. 6B illustrates the relation between objects managed by the running of the filter framework 219 in a state wherein two filters are in a valid state.

A Filter 1 object 503 is an object of a specific class, a specific form of the Filter abstract class 402. Reference to the ConnectorInputStream object of the Connector object 501 is maintained in the input attributes of the Filter 1 object 503. The Filter 1 object 503 applies filtering processing to a data stream that is read from the ConnectorInputStream object to which “input” points. Reference to the PipedOutputStream object of a Pipe object 504 is maintained in the output attributes of the Filter 1 object 503. The Filter 1 object 503 writes the data stream to which the filtering processing has been applied to the PipedOutputStream object to which “output” points.

The Pipe object 504 is a Pipe class 406 object. The Pipe object 504 holds a PipedOutputStream object and a PipedInputStream object in a connected state. The data stream is handed off to the PipedOutputStream object by being called up by the write method of the PipedOutputStream object of the Pipe object 504. The data stream can then be read out from the PipedInputStream object by being called up by the read method of the PipedInputStream object of the Pipe object 504.

A Filter 2 object 505 is an object of a specific class, a specific form of the Filter abstract class 402. Reference to the PipedInputStream object of the Pipe object 504 is maintained in the input attributes of the Filter 2 object 505. The Filter 2 object 505 applies filtering processing to a data stream read from the Pipe object 504 to which “input” points. Reference to the ConnectorOutputStream object of the Connector object 501 is maintained in the output attributes of the Filter 2 object 505. The data stream to which the filtering processing has been applied is written to the ConnectorOutputStream object of the Connector object 501 to which “output” points.

Thus, the handoff of a print data stream (large arrows in the diagram) is achieved between objects. A greater number of filter objects can be placed for data stream processing by placing the Pipe object 504 therebetween, in similar fashion.

FIGS. 7A through 7C are diagrams for describing a user interface for operating the filter framework 219 according to the embodiment. The user interface for operating the filter framework 219 is implemented as a Web application (Servlet) by the http service included in the standard library and framework 217 (FIG. 2). The user interface is operated from a Web browser running at the client. Alternatively, it may be implemented as an Applet-type service so as to be operated from the operating panel 18 of the image processing apparatus 1000.

FIG. 7A illustrates a user interface for installing and adding a new filter 221 to the filter framework 219 of the image processing apparatus 1000 of the embodiment. A filter installation screen 601 comprises a file name input field 602, a browse button 603, and an install button 604.

The user inputs a file path to the class file of the Filter abstract class 402 that stored in the file system of the client computer beforehand, and which the user wishes to install, into the file name input field 602.

When the user clicks on the browse button 603, a file selection dialog box provided by the Web browser of the client computer is opened. The user can browse through the file system of the client computer using the file selection dialog box, so as to select the class file of the filter abstract class 402 which the user wishes to install. The file path to the file which the user has selected via the file selection dialog box is automatically input into the file name input field 602.

Upon detection of the user clicking on the install button 604, the specified filter is transmitted to the Web application to be installed as a new filter. That is, the class file located at the file path that is inputted into the file name input field 602 is transmitted by the Web browser of the client computer to the Web application for new filter installation for which the image processing apparatus 1000 is standing by. The Web application which has thus received the class file stores the received class file in the non-volatile memory 3 of the image processing apparatus 1000. The class file is dynamically loaded into the interpreter environment 215 in order to generate an object instance. The generated file object is situated farthest downstream in the valid filter list which the filter framework runtime manages. If a valid filter object already exists in the filter list at this time, a new pipe object for linking the new filter object is generated.

When the user interface is implemented as a Web application, uploading of the implementation class of the filter to the image processing apparatus 1000 uses a file uploading specification, based on the HTML form, and that is stipulated by the RFC standard. Accordingly, the file name input field 602 and the browse button 603 are displayed in the Web browser of the client computer, and the install button 604 corresponds to “submit” in the form.

If the user interface is implemented as an Applet-type service, the screen 601 is displayed on the operating panel 18 of the image processing apparatus 1000. If the image processing device 1000 has a removable storage medium, a file path in the removable storage medium may be specified for the file specified in the file name input field 602. Alternatively, an arrangement may be made wherein a shared file, which is accessible by the image processing apparatus 1000 via network by a file transfer protocol such as http or FTP, is specified by a URL or the like.

FIG. 7B is a diagram for describing a user interface for placing a filter installed in the filter framework 219 of the image processing apparatus 1000 according to the embodiment.

In a filter placement screen 605, a table 606 shows a list of filter groups installed in the runtime of the filter framework 219. Each row in the table 606 corresponds to a filter that has been installed. There are checkboxes in the “select” column of the table 606, with filters in checked rows being selected for later-described operations. An “order” column in the table 606 shows “invalid” in the event that a filter is in an invalid state. If the filter is in a valid state, the “order” column indicates the order thereof, with a number allocated in ascending order from the upstream to the downstream direction in data stream processing. The filter name described in the name attribute of the filter object is displayed on a “name” column in the table 606.

The reference numerals 607 through 611 denote buttons for directing operations regarding the selected filter, which has been indicated by checking in the table 606. Upon the user clicking on the display details button 607, the detailed information relating to the filter selected in the table 606 is displayed. Examples of the detailed information include, but are not limited to, filter name, version number, description, class name, installation source class file name, i.e., file path or URL, and date and time of installation.

When the up button 608 is clicked, the order of the selected filter in the filter column is incremented by one in the upstream direction of data stream processing. When the down button 609 is clicked, the order of the selected filter in the filter column is decremented by one in the downstream direction of data stream processing. Each click of the valid/invalid button 610 toggles between the valid/invalid state of the selected filter, so that if the selected filter is in a valid state, clicking the valid/invalid button 610 places it in an invalid state, and if the selected filter is in an invalid state, the valid/invalid button 610 places it in a valid state. While a filter object in an invalid state is deleted, the Filter abstract class 402 remains in an installed state, under management of the filter framework runtime. When the uninstall button 611 is clicked, the class file of the selected filter is deleted from the interpreter environment 215 of the image processing apparatus 1000. When the OK button 621 is clicked, the filter placement, as configured via the setting screen, i.e., the filter placement screen 605, is settled on.

FIG. 7C is a diagram illustrating an example of a user interface for selecting whether a filter is applicable to handling a data stream.

The user interface shown in FIG. 7C is a selection screen 612 that is applicable to select a data stream, which is displayed to the user before displaying the filter installation screen 601 and the filter placement screen 605, thereby enabling the user to determine a data stream regarding which the user desires installation or settings to be made regarding filtering processing.

A list 613 provides a user interface whereby data streams existing within the image processing apparatus 1000 may be selected in list format. A field 614 displays the data streams selected from the list 613. An OK button 615 is a button for settling on the installation and management of filters regarding the data streams specified in the field 614. When the OK button 615 is pressed, the filter installation screen 601 and the filter placement screen 605 for the related data streams are displayed.

The method for selecting data streams for filtering processing is not restricted to the foregoing. For example, an arrangement may be made wherein filter attributes are provided to the Filter abstract class 402, such that data streams to be filtered are identified by making reference to the filter attributes when the filter is installed or managed.

With user interfaces such as the foregoing, one or more filters can be placed with regard to input data streams, i.e., processing request data streams, or desired intermediate data streams. Note that filters, or filter combinations, thus placed have been placed in the data path of the intermediate data stream via the layer interface 211, as shown in FIG. 4.

Also, as described above with reference to FIG. 17, according to the present embodiment, applicable “PDL type” and “job type” can be set with regard to the filters, or the filter combinations, placed vis-a-vis an intermediate data stream, according to the embodiment. For example, when an application conditions button 620 shown in FIG. 7B is pressed, the user interface shown in FIG. 18 comes up. In FIG. 18, the data stream to be handled is a “rendering data stream”, illustrating a display example of a case wherein the rendering data stream has been selected in the selection of the data stream (See 614, frame with square heavy line) in FIG. 7C, and the application conditions button 620 has been pressed in FIG. 7B. In FIG. 18, the PDL type or the job type to which the filter, or the combination of filters, should be applied is determined with a PDL type setting list box 1501 and a job type setting list box 1502. Clicking on the OK button 1503 finalizes the configuration. In this case, if the processing request data stream has the job type and a PDL type set herein, the rendering data stream included in the processing request data stream is subjected to processing by the filter that was assigned in FIG. 7B.

Whether or not to apply filtering processing has been described per the foregoing as being determined by the PDL type or the job type, but these are merely examples, and the embodiment is not restricted thereto.

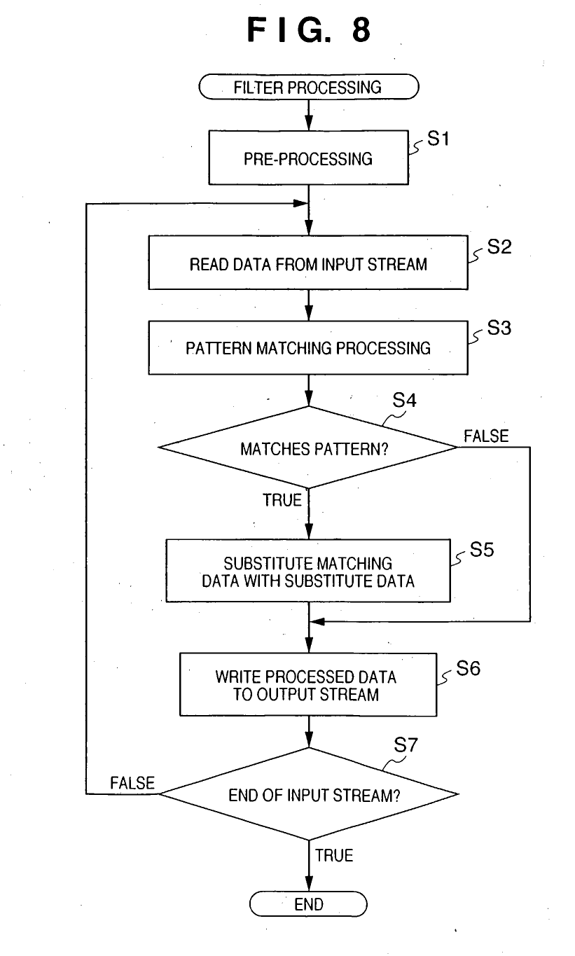

FIG. 8 is a flowchart illustrating the primary filtering processing procedure according to the embodiment.

The process is implemented as a run method of a specific filter class. The filter framework 219 generates a valid filter class object, and following setting up the input stream and output stream thereof, appropriates a thread (Thread object) for executing the run method of the object. Accordingly, the procedure is autonomously and concurrently executed in each of the filter objects that is managed by the filter framework 219.

Necessary pre-processing is performed in step S1. The pre-processing includes, but is not limited to, initialization of attributes which the filter 221 uses internally, pre-processing regarding pattern descriptions used for pattern matching, and processing for wrapping streams with a qualification class for adding functions that facilitate use of input/output streams. Examples of functions facilitating use of input/output streams include, but are not limited to, enabling read-ahead of input streams, and expanding buffering for effectively using system resources. The specific classes of Java.io.FilterInputStream and Java.io.FilterOutputStream are examples of qualification classes for adding such functions.

In step S2, data of an amount necessary for pattern matching processing is read out from an input stream set in the input attributes. In step S3, pattern matching for discovering data patterns to be operated on by the filter is performed. The data patterns to be operated on by the filter may be a fixed data string itself, or may be a description in a format language such as a regular expression. Various types of deployment for discovering data matching a pattern description from a data stream are widely known, with grep, sed, AWK, and Perl being particularly well-known.

Algorithms for efficiently performing pattern matching have been intensively studied. Known fixed pattern description methods include, but are not limited to, i) a method wherein the hash functions of the pattern description and a partial data stream are each compared, and a complete match is determined to exist only if the hash values agree, ii) the Knuth-Morris-Pratt algorithm, and iii) the Boyer-Moore algorithm. With pattern descriptions that use regular expressions, various types of algorithms are also known, which are based on format language theory, such as finite automatons. On the relatively recent Java platform, a class library for handling regular expressions, Java.util.regex, is included in the standard installation. There are cases wherein, for example, the state changes according to an upstream pattern in the data stream, and the interpretation of the lower stream pattern must be changed according to the changed state, and furthermore, the more difficult the description is with regular expressions and so forth, the more complicated the pattern matching required becomes. In such cases, an algorithm for evaluating the features itself of the pattern may be newly written as a Java program. Thus, straightforward implementation may be achieved, regardless of how complicated the pattern matching is.

In step S4, the results of the pattern matching are assessed, and if data matching the pattern description is discovered in the data stream, the process proceeds to step S5, and otherwise proceeds to step S6. In step S5, the operation according to the object of the filter is applied to the partial data string of the data stream matching the pattern description, and substituted with the results thereof.

In step S6, the processed partial data string, i.e., either the data string regarding which the pattern being monitored for did not appear, or a data string which has been subjected to the processing in step S5, regarding the data string including the pattern being monitored, is written to the output stream.

In step S7, an assessment is made regarding whether or not the input stream has ended, and if the input stream has ended, the process ends. Otherwise, the process returns to step S2, and the procedures are repeated.

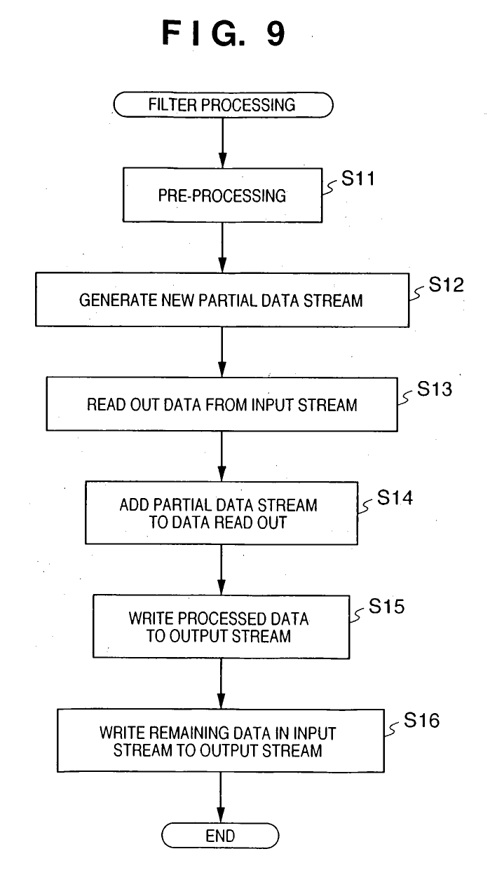

FIG. 9 is a flowchart illustrating a further example of filtering processing according to the embodiment.

The process is implemented as a run method of a specific filter class. The filter framework 219 generates a valid filter class object, and, following setting up the input stream and output stream thereof, appropriates a thread (Thread object) for executing the run method of this object. Accordingly, the process is autonomously and concurrently executed in each of the filter objects managed by the filter framework 219.

In step S11, necessary pre-processing is performed. The pre-processing includes, but is not limited to, initialization of attributes which the filter 221 uses internally, pre-processing regarding pattern descriptions used for pattern matching, and processing for wrapping streams with a qualification class for adding functions that facilitate use of input/output streams. Examples of functions facilitating use of input/output streams include, but are not limited to, enabling read-ahead of input streams, and expanding buffering for effectively using system resources. The specific classes of Java.io.FilterInputStream and Java.io.FilterOutputStream are examples of a qualification class for adding such functions.

In step S12, a new partial data stream is generated. In step S13, data of a pre-determined amount necessary for pattern matching processing is read out from an input stream set in the input attributes. In step S14, the partial data string generated in step S12 is added to the data stream that has been read in. In step S15, the processed partial data string is written into the output stream. In step S16, the remaining data in the input stream is written to the output stream.

FIG. 10 is a diagram for describing a processing request data stream according to the embodiment.

Reference numeral 801 denotes a processing request data stream. The processing request from the client to the image processing apparatus 1000 is performed by the client creating a processing request data stream 801 and transmitting it to the image processing apparatus 1000. Execution of the requested processing is carried out by the image processing apparatus 1000 processing the processing request data stream 801. The processing request data stream 801 can be generally divided into a device control instruction data stream 802 (equivalent to 351 in FIG. 3) and a rendering data stream 803 (equivalent to 352 in FIG. 3).

Described in the device control instruction data stream 802 are instructions to the image processing apparatus 1000 regarding processing requests other than rendering. Specifically, issuing the following instructions are commonly known, and are stipulated by functions of the image processing apparatus 1000. The “job type” attribute in line 1 represents the various types of jobs which the image processing apparatus 1000 can handle, and can take values that include, but are not limited to, “printing”, “secure printing”, and “image acquisition”. With a processing request such as “image acquisition”, wherein rendering instructions are not made, the rendering data stream 803 is generally not included in such a processing request data stream 801. The “number of copies” attribute in line 2 represents how many sets of printed articles are to be produced. The “page layout” attribute in line 3 represents page layout specifications. The page layout specifications include specifications for imposition of a plurality of pages on a single sheet, including but not limited to “1 page/sheet”, “2 pages/sheet”, or “4 pages/sheet”. The page layout specifications include specifications for enlarging one page and printing on multiple sheets, including but not limited to “poster (2×2)”, or “poster (3×3)”. The “placement order” attribute in line 4 represents the placement specifications at the time of page layout, and can take values that include, but are not limited to, “from upper left to right”, “from upper left down”, “from upper right to left”, or “from upper right down”. The “printing method” attribute in line 5 represents the printing method, and can take values that include, but are not limited to, “single-side printing”, “duplex printing”, or “binding printing”. The “binding side” attribute in line 6 represents the side of which a plurality of sheets are to be bound in the finishing processing, and can take values that include, but are not limited to, “long side (left)”, “long side (right)”, “short side (top)”, and “short side (bottom)”. The “discharge method” attribute in line 7 represents the finishing method, and can take values that include, but are not limited to, “unspecified”, “sorting”, “stapling”, and “hole punch”. The “paper feed” attribute in line 8 represents the paper, i.e., transfer paper, for image formation, and can take values that include, but are not limited to, “automatic”, “manual feed tray”, “cassette”, “deck”, or “plain paper”, “heavy paper”, “color paper”, or “OHP”. The “PDL used” attribute in line 9 is used when the processing request contents are rendering instructions, and represents the type of PDL used for the rendering data stream.

The rendering data stream portion 803 is used when the processing request contents are rendering instructions. A rendering data stream is generally configured with PDL.

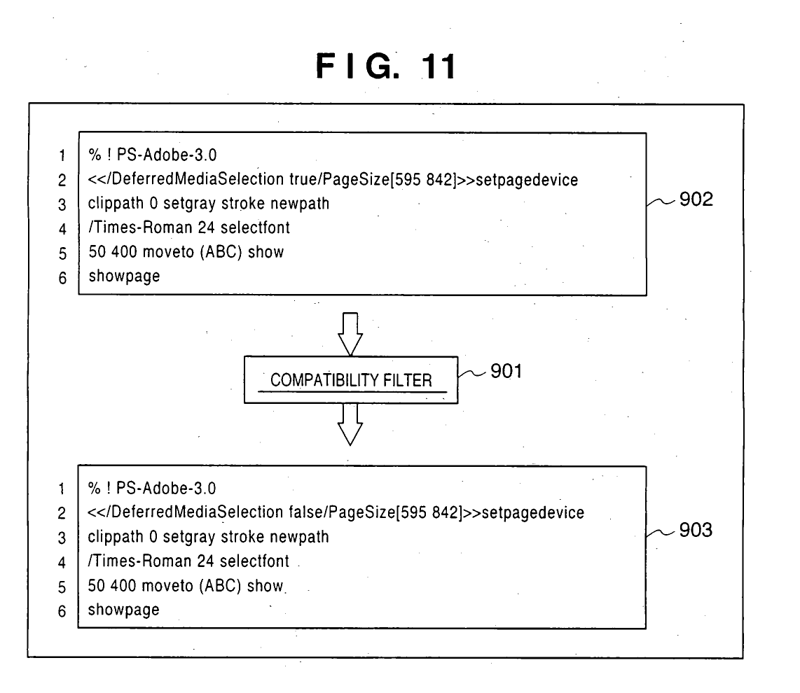

FIG. 11 is a diagram illustrating processing performed by a filter on a rendering data stream 803 according to the embodiment.

A compatibility filter 901 is a Filter class object of the rendering data stream 803, which implements processing for solving compatibility problems in the rendering data stream 803 within the input data stream, and writes out to the output stream. As a compatibility problem in the rendering data stream 803, description will be made regarding problems arising from differences in the interpretation of the Adobe PostScript specifications, which is a representative PDL, among vendors of image processing apparatuses, in their implementation thereof, and a solution thereof.

For example, the PostScript setpagedevice in a given vendor's image processing apparatus is interpreted and implemented as follows. If the value of the /DeferredMediaSelection parameter in setpagedevice is True, a printing paper request is displayed on a panel as a custom printing paper treatment. On the other hand, if the value is False, search for a standard paper size within a range of ±5 from the specified size, or follow PostScript Policy if there is no standard paper size. With, the PostScript setpagedevice in another vendor's image processing apparatus is interpreted and implemented as follows: if the value of the /DeferredMediaSelection parameter in setpagedevice is True, search for a standard sheet size that is exactly the specified size (no range) and if there is no standard printing paper size, treat as custom printing paper. On the other hand, if the value is False, search for a standard printing paper size within a range of ±5 from the specified size, or follow PostScript Policy if there is no standard printing paper size.

The embodiment presumes that an infrastructure environment for a backbone system provided by still another vendor has been built, assuming the behavior based on the latter of the two preceding interpretations. In this case, the former image processing apparatus will treat a printing request as a custom paper job, and thus, “no printing paper present” will be displayed on the operating panel, and the job will not be printed. Accordingly, the vendor of the former image processing apparatus needs to solve this compatibility problem, as inexpensively and speedily as possible. Such a demand can be handled, at least provisionally, by converting the /DeferredMediaSelection parameter in setpagedevice appearing in the printing request data stream from True to False. The compatibility filter 901 is a filter object acting to solve such problems. That is, the compatibility filter 901 performs pattern matching for setpagedevice with /DeferredMediaSelection having a value of True, and in the event of a match, a data stream wherein the True has been replaced with False is output.

Reference numeral 902 denotes PostScript print data, which is an example of a data stream inputted into the filter. The partial data that matches the pattern appears in line 2. Reference numeral 903 denotes an example of the output data stream wherein the input data stream 902 has been subjected to processing by the compatibility filter 901 and outputted in the form of filtered PostScript print data. The text string True in line 2 has been changed to False in the output data stream 903.

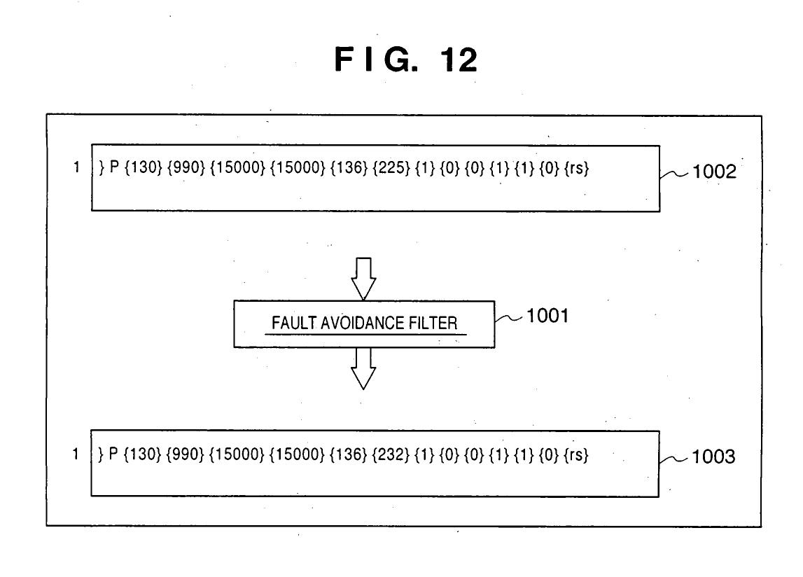

FIG. 12 is a diagram for describing filtering processing performed by a filter on a rendering data stream according to the embodiment.

In the foregoing example with reference to FIG. 11, data stream pattern matching and replacement techniques are used to solve compatibility problems based on differences in specifications between image processing apparatuses. In the example shown in FIG. 12, similar technology is used for emergency avoidance of implementation defects, including but not limited to, bugs in firmware, in an image formation apparatus. For example, assume that in a certain version release of a certain image processing apparatus, there is a bug wherein a rendering error occurs when the image width specified by a secure image region command VDM (Virtual Device Metafile) in the LIPS language (LIPS is a kind of Page Description Language) is not a multiple of eight.

Reference numeral 1001 denotes a fault avoidance filter, which detects a pattern in a LIPS data stream 1002 which would elicit a fault, and converts the data stream 1002 into a data stream 1003 whereby the functions thereof would be achieved without manifesting the fault. For example, the fault avoidance filter 1001 detects a pattern in the data stream 1002 which would elicit a fault, i.e., the VDM image width is 225, which is not a multiple of eight, and converts the VDM image width in the detected pattern into a multiple of eight, in this case, 232, which is a value greater than 225.

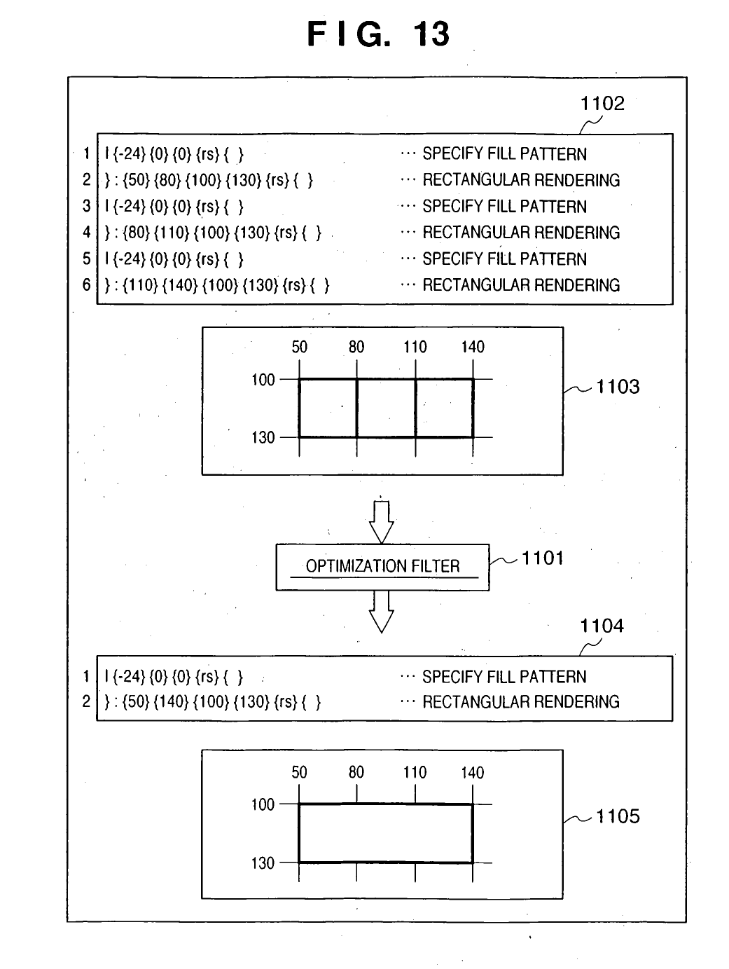

FIG. 13 is a diagram for describing filtering processing performed by an optimization filter on a rendering data stream according to the embodiment.

The optimization filter 1101 represents an optimization filter class object pertaining to a rendering data stream. The optimization filter 1101 reads out an input stream, detects PDL data described redundantly which appears in the data stream, converts the detected PDL data into data of the same function but with greater efficiency, and writes it to the output stream. The PDL data stream generated by an image processing apparatus driver tends to include redundant patterns, such as repetition, due to circumstances of the print request system or the applications. The optimization filter 1101 recognizes such redundant description patterns as a type of idiom, and replaces them with equivalent expressions which are more efficient.

Reference numeral 1102 illustrates an example of an input data stream that is inputted into the optimization filter 1101. A description is made in the input stream 1102 to repeat filling three squares in order to fill a horizontal rectangle, as depicted in No. 1103. Reference numeral 1104 illustrates an example of an output data stream from the optimization filter 1101. The optimization filter 1101 has detected the redundant repetition pattern, and has rewritten it as an equivalent fill 1105 of a single horizontal rectangle.

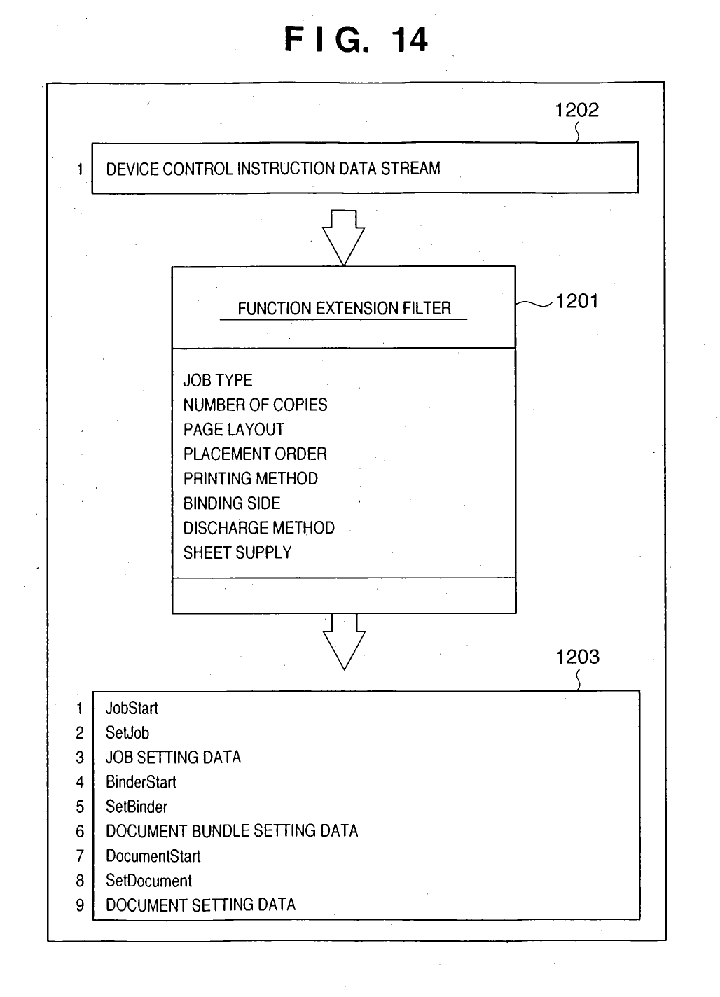

FIG. 14 is a diagram for describing processing performed by a function adding filter with regard to a device control instruction data stream according to the embodiment.

Reference numeral 1201 illustrates an example of a function extension filter class object, to be applied to a device control instruction data stream 351. The function extension filter 1201 reads out an input data stream 1202, performs processing such as data conversion and adding data to add new functions according to the input data stream, and writes to an output data stream. The following is an example of function extension under these circumstances. Suppose that a customer system has a dedicated PDL driver, and that the PDL driver does not support new capabilities of a new image processing apparatus, including but not limited to duplex printing or various types of finishing. In such an instance, the new function of the apparatus can be had by providing filter support on the image processing apparatus, without changing the driver.

As attributes, the function extension filter 1201 has apparatus control instruction configurations for achieving new capabilities of the image processing apparatus whereon the filter is running. The filter object attribute values are saved in the non-volatile memory of the apparatus as well, and the state of the objects are saved even in the event that the power of the apparatus is turned off and restarted. Specifically, the values are stipulated by the functions which the image processing apparatus has.

The input data stream 1202 is a data stream of the printing data stream that is inputted into the function extension filter 1201. The data stream 1202 is a device control instruction data stream 351 that is derived from a processing request data stream, that has in turn been generated by a conventional application and divided within the image processing apparatus 1000 by which it was received. Alternatively, the data stream 1202 is an device control instruction data stream 351 that is obtained by a processing request data stream that is generated by a driver of the image processing apparatus 1000, and that is divided in turn within the image processing apparatus.

The output data stream 1203 represents a data stream of the device control instruction data stream which the function extension filter 1201 sequentially processes and outputs. In addition to the simple processing request data stream in the input data, various types of print job description data are inserted, in order to make best use of the new functions of the image processing apparatus 1000. A print job description can express nested structures, and various attributes, such as the attributes of the function extension filter 1201, can be specified at each of the hierarchical levels on a per job basis, a per process basis, such as finishing performed on a plurality of documents, and a per individual document basis.

In the output data stream 1203, JobStart in line 1 represents starting the job. SetJob in line 2 means the commencement of settings jobs on a per job basis. Job configuration data in line 3 indicates the presence of setting data for individual jobs of various types. BinderStart in line 4 represents starting binding a plurality of documents into one. SetBinder in line 5 signifies commencing settings on a per bound document basis. Document bundle setting data in line 6 signifies the presence of setting data on a per bound document basis. DocumentStart in line 7 is data representing starting of a document. SetDocument in line 8 represents starting of settings on a per document basis. Document setting data in line 9 indicates the presence of setting data on a per document basis here.

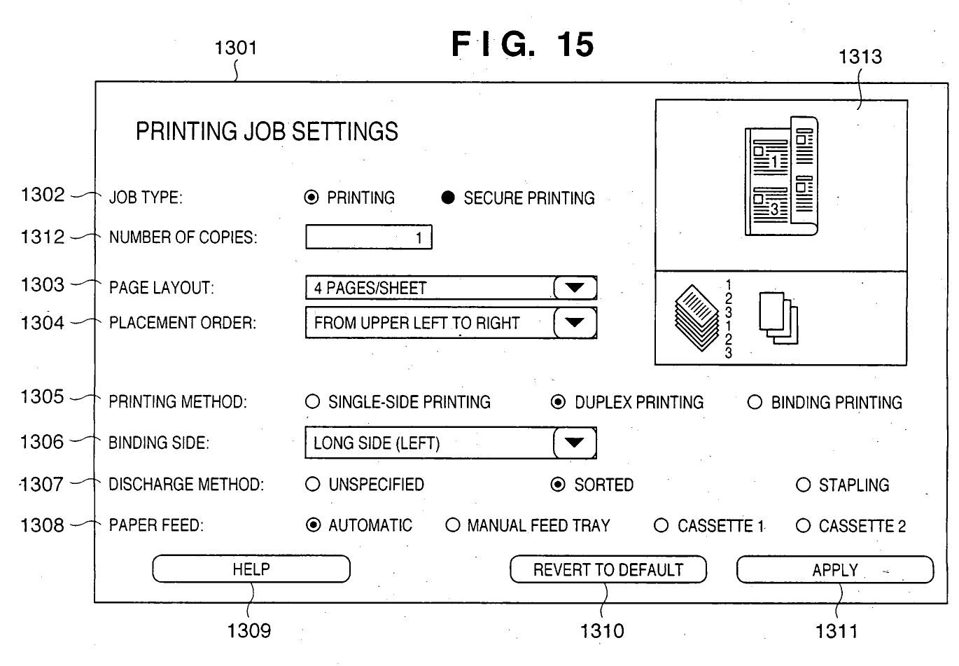

FIG. 15 is a diagram illustrating an example of a user interface for operating the function extension filter 1201.

The user interface for filter operations is deployed as a Web application (Servlet) by the HTTP service included in the standard library and framework 217. The user interface is operated from a Web browser running on the client. Alternatively, the user interface may be implemented as an Applet-type service so as to be operated from the operating panel 18 of the image processing apparatus 1000.

Reference numeral 1301 illustrates a basic operation screen of the function extension filter 1201. The user can make various operations using this screen, such as confirming and changing filter object attributes. Reference numeral 1302 denotes a job type section, which is used for operating the job type attribute. Reference numeral 1312 denotes a number of copies section, which is used for operating the number of copies attribute. Reference numeral 1303 denotes a page layout section, which is used for operating the page layout attribute. Reference numeral 1304 denotes a placement order section, which is used for operating the placement attribute. Reference numeral 1305 denotes a printing method section, which is used for operating the printing method attribute. Reference numeral 1306 denotes a binding side section, which is used for operating the binding side attribute. Reference numeral 1307 denotes a discharge method section, which is used for operating the discharge method attribute. Reference numeral 1308 denotes a paper feed section, which is used for operating the paper feed attribute. A help button 1309 is used for displaying descriptions including, but not limited to how to use the filters, functions thereof, and meanings of the attributes. A revert to default button 1310 is used in the event of restoring the configurations to their defaults. An apply button 1311 is used when attribute value changing operations are to be applied, so that the new values are actually set as the attributes of the filter object. Reference numeral 1313 denotes a preview icon, which displays a model view corresponding to the state of the values of several important attributes for confirming the various attributes on the screen.

The first embodiment, as described, has the following advantages:

(1) A print request reception server is statically implemented as firmware, and an interface is provided for handing off a data stream received by the reception server to filtering software, which is capable of dynamic loading and dynamic linking, and installed in an embedded Java environment. Accordingly, the stable components and the dynamic components can be clearly separated, facilitating avoiding inefficient processing, such as replacing the entire device firmware with dynamic and redundant software, or the inefficiency of implementing duplicate software in the Java environment. Thus, a filter framework may be achieved which is reasonable in both cost and development load terms. Furthermore, the dynamic addition and substitution of filters for devices already delivered can be easily achieved, allowing customer needs to be met more inexpensively and rapidly.

(2) Filters are implemented in a more refined Java environment. This allows a sophisticated pattern matching algorithm, wherein dynamic memory management, which is difficult with embedded systems, is necessary, to be achieved with ease. The software also has an advanced modular design, allowing strong reusability, facilitating ease of employment of a design pattern based on an object-oriented paradigm. Consequently, a highly productive filter implementation may be achieved.

(3) Using pattern matching, a filter may be used to discover PDL data within the input data stream which would be problematic with regard to compatibility with another implementation, and the PDL data may be altered as appropriate. Accordingly, it has been possible to resolve compatibility problems and faults inexpensively. Particularly, such resolutions may be achieved with a solution restricted to the image processing apparatus without affecting the systems, the applications, or the image processing apparatus drivers, in the customer environment. Moreover, if a filter is not installed, it is possible to avoid overhead due to interposition of the filter framework, and the standard data processing performance of the image processing apparatus may be maintained, even if no filter is installed.

(4) A filter that may be extended in a flexible fashion in a Java environment may be used to recognize a redundant description pattern as a type of idiom, which may in turn be replaced with a more efficient equivalent expression. Accordingly, it is possible to improve the printing processing performance without affecting the principal component of the PDL processing system at all. Additionally, as optimization is performed with a solution restricted to the image processing apparatus, there is no need to revamp the systems, the applications, or the image processing apparatus drivers in the customer environment. Strong filter productivity and ease of maintenance such as installation allow achievement of optimization that is suited to each customer's usage circumstances.

(5) A filter that may be extended in a flexible fashion in a Java environment may allow the use of a new function of the image processing apparatus, by adding data necessary to take advantage of the new function. The new function may thus be fully used, even when combined with customer systems, applications, or image processing apparatus drivers that do not support the new function of the image processing apparatus.

(6) A user interface for operating the configuration of additional functions has been provided for the filter operating in the firmware, with the Java environment serving as yet another software platform layer for the firmware. Accordingly, function expansion corresponding to individual user usage circumstances can be promptly provided.

(7) It is possible to perform optimal filtering processing for each of: device control instruction data streams that are constituted of instruction commands relating to device control; and rendering data streams that are constituted of instruction commands relating to rendering, such as PDL.

(8) Interposing a data stream attribute management module 228 when processing a given data stream allows the module that performs the data stream processing to determine application of filtering processing by using information extracted from another data stream. Specifically, application of filtering processing to rendering data can be performed in accordance with job type and PDL type, as described in the device control instruction data stream, which is called JL (Job Language).

### Second Embodiment

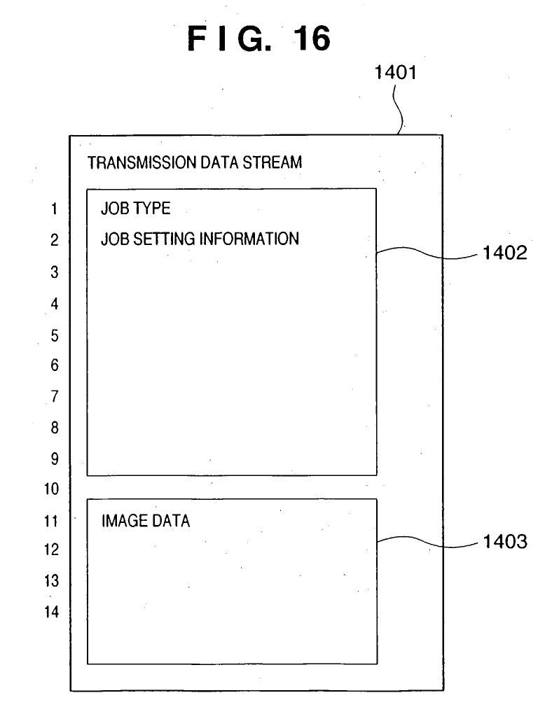

FIG. 16 is a diagram for describing a transmission data stream 1401 according to a second embodiment of the present invention. The hardware configuration and software configuration of the second embodiment are the same as those in FIGS. 1 through 4 described above, so description thereof will be omitted.

In response to a processing request from a client, the image processing apparatus 1000 transmits image data and so forth to the destination which the client has specified. At this time, the image processing apparatus 1000 generates this transmission data stream 1401, which is transmitted by the data transmission/reception module 202. The transmission data stream 1401 can be generally divided into a data stream portion 1402 describing the job type of the transmission data stream, and the image data stream 1403. Described in the data stream portion 1402 is information other than the image data itself. The format of the data stream portion 1402 is stipulated by the functions of the image processing apparatus 1000. At the time of performing data transmission, the data stream portion 1402 is added to the image data by the job control module 205 or the embedded application 203, and is transmitted from the data transmission/reception module 202 as a transmission data stream. The image data stream 1403 is generated by the scan image data stream 360 (FIG. 3) input from the image reading unit 19 being processed at the image processing module 209. Note that filtering processing can be performed regarding the transmission data stream 1401, data stream portion 1402, and image data stream 1403, the same as described above.

According to the second embodiment described above, optimal filtering processing can be performed for each of the scan image data stream 360, image data stream, and transmission data stream 359, present within the image processing apparatus.

### Other Embodiments

Data streams other than those described above which exist within the image processing apparatus include the display list 355 generated due to PDL processing, the final image data stream 357 finally generated in the image processing apparatus, the intermediate image data stream 356 generated for generating the final image data stream 357, and so forth. Each of the data streams has the format thereof stipulated by the functions of the image processing apparatus. Due to the configuration being the same as the above-described configuration, optimal filtering processing can be performed for each of the data streams.

Also, a configuration may be made of the filters so as to handle text data strings to be printed, instead of control data within the printing data stream. For example, an arrangement may be made with function extending filters wherein occurrences of particular text string patterns are detected in a text data string to be printed, and in the event that these match particular text string patterns, control data equivalent to the text string is generated and substituted or inserted. For example, an arrangement may be made wherein a customer performs input as text using an application such as a word processor, and particular text strings are converted into vector rendering commands at the time of printing via a normal driver of the image processing apparatus. In this case, a configuration can be made for the filter at the image processing device side to convert particular text strings for example, into command strings such as vector rendering commands in order to render corresponding images (logos, marks, watermarks, etc.).

While a Java virtual machine environment has been used as the interpreter environment within the firmware in the above-described embodiments, the present invention is not restricted to this. The same advantages, such as addition of dynamic filters and separation of the firmware portion can be obtained even in cases of assembling an interpreter environment of another script language or the like into the firmware.

Also, many other interpreter environments enabling highly efficient development, such as object-oriented interpreter environments, exist, and the same advantages, such as filter productivity can be obtained using these as well. Particularly, with regard to data stream processing based on pattern matching, options such as sed, AWK, Perl, and so forth, are also suitable.

While embodiments of the present invention have been described above, the present invention may be applied to a system configured of multiple devices, or may be applied to a device formed by a single unit.

The present invention includes a case wherein a software program is directly or remotely supplied to a system or device, with the functions of the above-described embodiment being realized by the system or device reading out and executing the program code supplied thereto. In this case, the supplied program does not have to assume the from of a program, as long as possessing the functionality of a program. Accordingly, in order to achieve the function processing of the present invention with a computer, the program code to be installed in the computer itself also realizes the present invention. That is to say, a computer program for realizing the function processing of the present invention is itself also included in the present invention. In this case, the program may be in any form, such as object code, a program executed by an interpreter, script data supplied to an operating system, or the like, as long as the program has the functions of a program.

Examples of storage media for supplying the program include the following: floppy disks, hard disks, optical disks, magneto-optical (MO) disks, CD-ROM, CD-R, CD-RW, magnetic tape, non-volatile memory cards, ROM, DVD (DVD-ROM, DVD-R), and so forth. Further, examples of methods for supplying the program include accessing a homepage on the Internet using a browser from a client computer, and downloading the computer program according to the present invention itself, or a file thereof which has been compressed and has automatic installation functions, from the homepage to a recording medium such as a hard disk or the like. Also, this may be realized by dividing the program code making up the program according to the present invention into multiple files, and downloading the files from different homepages. That is to say, a WWW server, enabling multiple users to download the program file for realizing the function processing of the present invention on a computer, is itself included in the present invention.

Also, the program according to the present invention may be encrypted and stored in a recording medium such as a CD-ROM for distribution, with users who have cleared certain conditions being enabled to download key information for decryption from a homepage on the Internet, execute the encrypted program using the key information, and install the program on a computer.

Also, besides the functions of the above embodiment being realized by executing the program that has been read out, the functions of the above embodiment may be realized in cooperation with the operating system or the like running on the computer based on instructions of the program. In this case, the operating system or the like performs part or all of the actual processing, and the functions of the above embodiment are realized by the processing thereof.

Further, the program read but from the recording medium may be written to memory of a function expansion board inserted to the computer or a function expansion unit connected to the computer, whereby part or all of the functions of the above embodiment is realized. In this case, following the program being written to the function expansion board or the function expansion unit, a CPU or the like provided to the function expansion board or the function expansion unit performs part or all of the actual processing, based on instructions of the program.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2005-360836 filed Dec. 14, 2005, which is hereby incorporated by reference herein in its entirety.

1. An information processing apparatus having, in a native environment configured based on a first command group processed by a processor which constitutes hardware, an interpreter environment for dynamically executing a program configured based on a second command group defined independently from said first command group, said apparatus comprising:
a data stream reception unit configured to receive an input data stream including a processing request from a client in said native environment;
a data processing unit configured to divide said input data stream into a plurality of stages and generating an intermediate data stream at each stage in said native environment;
a filter unit configured to generate a filtered data stream by filtering an intermediate data stream generated by said data processing unit in said interpreter environment;
an interface unit configured to extract and write back, from and to said filter unit, an intermediate data stream generated by said data processing unit, in said native environment;
a filter management unit configured to hand off an intermediate data stream generated by said data processing unit to said filter unit via said interface unit, and to take out the filtered data stream via said interface unit, in said native environment; and
a control unit configured to control execution of handing over an intermediate data stream by said filter management unit to said filter unit based on the contents of information of an item specified beforehand contained in said input data stream, in said native environment.

2. The information processing apparatus according to claim 1, further comprising a transmission unit configured to transmit an intermediate data stream processed by said filter unit to an information processing apparatus.

3. The information processing apparatus according to claim 1, further comprising:
a setting unit configured to set, regarding items contained in an input data stream, an item to be used as said item specified beforehand for determining whether or not to hand off intermediate data to said filter unit, and set conditions for deciding whether or not to hand off the intermediate data to said filter unit based on said items;
wherein said control unit controls execution of handing over of said intermediate data stream to said filter means by said filter management unit, based on information of said item specified beforehand contained in said input data stream, and determining conditions set by said setting unit.

4. The information processing apparatus according to claim 1, wherein said input data stream is divided into a plurality of intermediate streams including a first intermediate stream and a second intermediate stream by said data processing unit;
and wherein said control unit extracts information of said item specified beforehand from said first intermediate stream, and controls execution of handing off said second intermediate stream to said filter unit by said filter management unit, based on the contents of said information.

5. The information processing apparatus according to claim 1, wherein said client is an information processing apparatus connected via a network, or is built into said information processing apparatus.

6. The information processing apparatus according to claim 1, wherein said intermediate data stream generated by said data processing unit includes a device control instruction data stream for giving device control instructions to said information processing apparatus, a rendering data stream for giving rendering instructions to said information processing apparatus, an intermediate image data stream generated by processing said device control instruction data stream and said rendering data stream, and a final image data stream generated by processing said intermediate image data stream.

7. The information processing apparatus according to claim 1, wherein said filtering processing by said filter unit includes processing for adding a new data stream to an intermediate data stream.

8. The information processing apparatus according to claim 1, wherein said filtering processing by said filter unit includes processing for substituting a particular data stream of an intermediate data stream with another data stream.

9. The information processing apparatus according to claim 1, further comprising a unit configured to operate processing parameters at said filter unit, using a user interface in said interpreter environment.

10. The information processing apparatus according to claim 1, wherein said interpreter environment provides a thread mechanism for programs running on said interpreter environment, and wherein said filter unit autonomously executes filtering processing under independent execution contexts with said thread mechanism.

11. The information processing apparatus according to claim 1, wherein said interpreter environment is based on a Java platform.

12. The information processing apparatus according to claim 1, wherein said filter management unit places a filter function selected from one or a plurality of filter functions possessed by said filter unit in an intermediate data stream path formed through said interface unit.

13. The information processing apparatus according to claim 12, further comprising a filter placement operating unit configured to provide a user interface for instructing placement of filter functions selected from a plurality of filter functions managed by said filter management unit.

14. The information processing apparatus according to claim 12, wherein, in the event that no filter function is placed in said intermediate data stream path, said filter management unit does not hand off said intermediate data stream to said filter unit.

15. The information processing apparatus according to claim 12, further comprising filter introduction unit configured to for externally introduce a program file for realizing said filter functions into said apparatus and placing under the management of said filter management unit.

16. A control method of an information processing apparatus having, in a native environment configured based on a first command group processed by a processor which constitutes hardware, an interpreter environment for dynamically executing a program configured based on a second command group defined independently from said first command group, said method comprising:
a data stream reception step of receiving an input data stream including a processing request from a client in said native environment;
a data processing step of dividing said input data stream into a plurality of stages and generating an intermediate data stream at each stage interpreted in said native environment;
a filter step of generating a filtered data stream by filtering an intermediate data stream generated in said data processing step in said interpreter environment;
an interface step of extracting and writing back, from and to said filter step, an intermediate data stream generated in said data processing step, in said native environment;
a filter management step of handing off an intermediate data stream generated in said data processing step to said filter step via said interface step, and taking out the filtered data stream via said interface step, in said native environment; and
a control step of controlling execution of handing off an intermediate data stream by said filter management step to said filter step based on the contents of information of an item specified beforehand contained in said input data stream, in said native environment.

17. A computer-executable program, stored in a computer readable medium, for implementing a control method of an information processing apparatus having, in a native environment configured based on a first command group processed by a processor which constitutes hardware, an interpreter environment for dynamically executing a program configured based on a second command group defined independently from said first command group, said program comprising:
a data stream reception step of receiving an input data stream including a processing request from a client in said native environment;
a data processing step of dividing said input data stream into a plurality of stages and generating an intermediate data stream at each stage interpreted in said native environment;
a filter step of generating a filtered data stream by filtering an intermediate data stream generated in said data processing step in said interpreter environment;
an interface step of extracting and writing back, from and to said filter step, an intermediate data stream generated in said data processing step, in said native environment;
a filter management step of handing off an intermediate data stream generated in said data processing step to said filter step via said interface step, and taking out the filtered data stream via said interface step, in said native environment; and
a control step of controlling execution of handing off an intermediate data stream by said filter management step to said filter step based on the contents of information of an item specified beforehand contained in said input data stream, in said native environment.
